(19) United States
(12) Patent Application Publication
(10) Pub. No.: US 2012/0133705 A1
(43) Pub. Date: May 31, 2012

(54) LIQUID JETTING HEAD, LIQUID JETTING RECORDING DEVICE, AND METHOD FOR REFILLING LIQUID JETTING HEAD WITH LIQUID

(76) Inventors: Akifumi Sakata, Chiba-shi (JP); Kazuyoshi Tominaga, Chiba-shi (JP); Toshiaki Watanbe, Chiba-shi (JP); Ayako Kayama, Chiba-shi (JP)

(21) Appl. No.: 13/138,106

(22) PCT Filed: Dec. 1, 2009
(86) PCT No.: PCT/JP2009/070197

§ 371 Date: Jul. 29, 2011

(30) Foreign Application Priority Data
Jan. 9, 2009 (JP) 2009-003610

(51) Int. Cl. B41J 2/165

(52) U.S. Cl. 347/30

(57) ABSTRACT

Provided are a liquid jet head and a liquid jet recording apparatus which are capable of improving ability to collect excess liquid to prevent contamination with excess liquid and which are capable of stabilizing jetting of liquid after the liquid is filled. A liquid jet head includes a nozzle guard (24) for covering a periphery of a nozzle column (31c), the nozzle guard having a slit (24c) formed therein which is opposed to the nozzle column (31c), and a suction flow path (15) connected to a suction pump for sucking excess ink which leaks from the nozzle column (31c), in which inside space of the nozzle guard (24) is partitioned into first space (S1) and second space (S2), and the first space (S1) and the second space (S2) communicate with each other via a communication hole group (31f) in a nozzle plate (31).

### TECHNICAL FIELD

The present invention relates to a liquid jet head and a liquid jet recording apparatus for jetting liquid from nozzles to record an image or text on a recording medium.

### BACKGROUND ART

Generally, a liquid jet recording apparatus, for example, an ink jet printer which carries out various kinds of printing, includes a transfer apparatus for transferring a recording medium and an ink jet head. As an ink jet head used here, there is known an ink jet head including a nozzle body (jetting body) having a nozzle column (jetting hole column) formed of a plurality of nozzle holes (jetting holes), a plurality of pressure generating chambers which are paired with and communicate with the nozzle holes, respectively, an ink supply system for supplying ink to the pressure generating chambers, and a piezoelectric actuator disposed adjacent to the pressure generating chambers, in which the piezoelectric actuator is driven to pressurize the pressure generating chambers to cause ink in the pressure generating chambers to be discharged from nozzle orifices in the nozzle holes.

As a kind of such an ink jet printer, there is known an ink jet printer in which a carriage for moving the ink jet head in a direction orthogonal to the direction of transfer of recording paper (recording medium) is provided and printing is carried out on the recording paper. In an inkjet printer of such a kind, a service station for maintenance is provided in a movable range of the ink jet head, and the ink jet head is moved to the service station at which the nozzle holes are cleaned and the ink jet head is capped and sucked under negative pressure to initially fill the nozzle holes with ink.

An ink jet printer of a kind which is different from the kind of the above-mentioned ink jet printer is used for a relatively large-sized recording medium such as a box and carries out printing on a recording medium which is transferred under a state in which an ink jet head is fixed. In an ink jet printer of this kind, the ink jet head cannot be moved, and there is not enough space for providing a service station between the ink jet head and a recording medium or below the inkjet head. Therefore, when the pressure generating chambers are initially filled with ink, ink is normally pressurized from the ink supply system side during being filled.

In this pressurized filling, in order to prevent contamination of the ink jet head and of places in proximity to the ink jet printer with excess ink which droops from the nozzle holes, and in order to prevent unstable discharge of ink after the filling of the ink, it is necessary to take measures of removing excess ink. This is not limited to initial filling, and the same can be said with regard to a case in which ink that droops on a nozzle body in normal use is collected.

As measures against the above-mentioned problem, for example, as described in Patent Document 1, an ink jet head is disclosed in which an ink guide member that is formed of a plate-like porous absorber and protrudes outward from a nozzle formation surface and a block-shaped ink absorber connected to the ink guide member are provided below the ink jet head, excess ink is received and guided to the ink absorber by the ink guide member, and the guided excess ink is absorbed in the ink absorber.

Patent Document 1: JP 05-116338 A

### DISCLOSURE OF THE INVENTION

### Problem to be Solved by the Invention

However, in the conventional technology, there is a problem in that, because the ink guide member and the ink absorber are provided below the ink jet head, space below the ink jet head may not be effectively used. Another problem is that, therefore, when an ink jet printer is designed under certain constraints, printing cannot be carried out on a lower portion of a recording medium.

Still another problem is in that, because the ability to collect excess ink is insufficient, places around the head become dirty.

The present invention has been made in view of the above, and an object of the present invention is to provide a liquid jet head and a liquid jet recording apparatus which are capable of improving ability to collect excess liquid to prevent contamination with excess liquid and which are capable of stabilizing jetting of liquid after the liquid is filled.

### Means for Solving the Problems

In order to solve the problems described above, the present invention adopts the following means.

As solving means related to a liquid jet head, a liquid jet head for jetting liquid from a jetting hole column includes: a jetting body guard for covering a periphery of the jetting hole column, the jetting body guard having a slit formed therein which is opposed to the jetting hole column; a suction flow path connected to a sucking portion for sucking the liquid which leaks from the jetting hole column; and a partitioning portion for partitioning first space inside the jetting body guard and second space to which a suction port of the suction flow path is open, in which the partitioning portion has at least one communication hole formed therein for communication between the first space and the second space.

According to the structure, when gas in the second space is sucked, gas in the first space flows in the second space via the communication hole, and gas in the second space is sucked with the sucking portion from the suction port via the suction flow path, and hence the second space is depressurized to become a second negative pressure chamber.

When the second space becomes the second negative pressure chamber, gas in the first space flows in the second negative pressure chamber via the communication hole. Here, outside gas flows in the first space via the slit. By sucking the gas into the second negative pressure chamber via the first space, the first space is depressurized to become a first negative pressure chamber. Here, because gas flows in the second negative pressure chamber only from the first negative pressure chamber and via the communication hole, the extent of the negative pressure in the second negative pressure chamber is higher than that in the first negative pressure chamber.

With this, in initial filling of liquid or the like, excess liquid which leaks from the jetting hole column may be promptly sucked into the second negative pressure chamber from the communication hole in proximity thereto together with gas which flows in the second negative pressure chamber. Here, excess liquid sucked into the second negative pressure chamber moves through the second negative pressure chamber under a state in which the excess liquid is prevented from leaking from the communication hole to the first negative pressure chamber, and is sucked from the suction port into the suction flow path to be discharged to the outside. Therefore, compared with a case in which the suction port is open to the first space, excess liquid may be reliably prevented from leaking via the slit and the ability to collect excess liquid may be improved.

Therefore, contamination with excess liquid may be prevented with a simple structure and initial filling of the liquid jet head may be achieved without providing a complicated service station as in a conventional case. Accordingly, jetting of the liquid after the liquid is filled may also be stabilized. Further, because excess liquid may be collected inside the jetting body guard, space used for collecting excess liquid may be extremely small to improve the space factor of the liquid jet head. This may improve the flexibility in designing the liquid jet head.

Further, the at least one communication hole is provided at a location which is not opposed to the suction port of the suction flow path.

According to the structure, by disposing the communication hole and the suction port so as not to be opposed to each other, gas which flows from the first negative pressure chamber into the second negative pressure chamber does not directly reach the suction port but, after passing through the second negative pressure chamber, reaches the suction port, and thus, the negative pressure state in the second negative pressure chamber may be kept satisfactory. This enables prompt collection of excess liquid.

Further, the at least one communication hole includes a plurality of communication holes formed around the jetting hole column.

According to the structure, by forming the plurality of communication holes around the jetting hole column, excess liquid which leaks from the jetting holes may be sucked from any of the communication holes. Therefore, excess liquid may be promptly sucked from a communication hole in proximity thereto, and thus, the ability to collect excess liquid may be improved.

Further, the liquid jet head further includes: a jet plate having the jetting hole column formed therein; and a jet cap to which the suction port is open and to which the jet plate is stuck, in which: the jet cap has a groove portion formed therein on a side of a surface to which the jet plate is stuck; the suction flow path is open to the groove portion; the groove portion is blocked by the jet plate; an inside of the groove portion is the second space; and the jet plate is the partitioning portion.

According to the structure, by blocking the groove portion in the jet cap by the jet plate, the jet plate functions as a partitioning portion and the second space is formed inside the jetting body guard. Therefore, the space factor of the liquid jet head may be improved with a simple structure.

Further, because it is not necessary to provide a partitioning portion separately, the number of parts and the manufacturing cost may be reduced.

Further, an absorber for absorbing the liquid which flows in the second space is provided in the second space.

According to the structure, because the absorber is provided in the second space, excess liquid sucked into the second negative pressure chamber may be reliably absorbed, and excess liquid may be prevented from leaking from the communication hole to the first negative pressure chamber.

Further, the suction port of the suction flow path is disposed below the jetting hole column when the jetting hole column is disposed vertically.

According to the structure, by disposing the suction port below the jetting hole column, excess liquid passes in the direction of gravity inside the jetting body guard, and thus, excess liquid inside the jetting body guard may be sucked continuously and reliably.

Further, the suction port of the suction flow path is disposed above the jetting hole column when the jetting hole column is disposed vertically.

According to the structure, by disposing the suction port above the jetting hole column, space below the liquid jet head maybe effectively used to improve the space factor. Therefore, the jetting holes may be set in a lowest possible portion of the liquid jet head, and printing on a lower end portion of a recording medium may be carried out easily.

Further, a recessed portion which is recessed toward the first space side is formed in a top plate portion of the jetting body guard, and the slit is formed in a bottom surface of the recessed portion.

According to the structure, because the slit is formed in the bottom surface of the recessed portion, even if the jetting body guard is brought into contact with a recording medium or the like, the probability of contact of a water-repellent film in proximity to the slit with the recording medium or the like is reduced, and the water-repellent film may be prevented from peeling off.

Further, when liquid is jetted toward a recording medium under a state in which the liquid nozzles of the liquid jet head are oriented downward, even if excess liquid remains in the inside space after the pressure in the negative pressure chamber recovers, excess liquid may be effectively prevented from leaking via the slit.

Further, a ring-shaped protruding wall which protrudes to the first space side and which surrounds the slit in a shape of a ring is formed on a top plate portion of the jetting body guard.

According to the structure, because the ring-shaped protruding wall blocks excess liquid from running on an inner surface toward the slit, excess liquid may be prevented from leaking via the slit. In particular, when liquid is jetted toward a recording medium under a state in which the liquid nozzles of the liquid jet head are oriented downward, even if excess liquid remains in the inside space after the pressure in the negative pressure chamber recovers, excess liquid may be effectively prevented from leaking via the slit.

Further, as solving means related to a liquid jet recording apparatus, a liquid jet recording apparatus includes: the liquid jet head according to the present invention; a liquid supply portion formed to be capable of supplying the liquid to the liquid supply system; and the sucking portion connected to the suction flow path, for sucking the liquid which leaks from the jetting hole column.

According to the structure, because the above-mentioned liquid jet head according to the present invention is included, contamination with excess liquid may be prevented with a simple structure and initial filling of the liquid jet recording apparatus may be achieved without providing a complicated service station as in a conventional case. Accordingly, jetting of the liquid after the liquid is filled may also be stabilized. Further, the ability to collect excess liquid may be improved, and still, space used for collecting excess liquid may be extremely small to improve the space factor of the liquid jet head. This may improve the flexibility in designing the liquid jet head.

Further, because it is not necessary to attach the sucking portion on the liquid jet head side, the structure of the liquid jet head may be simplified and the liquid jet head may be miniaturized.

Further, as solving means related to the liquid jet recording apparatus, there is adopted means in which any one of the liquid jet recording apparatuses adopting the above-mentioned solving means includes a reuse liquid supply system for collecting by sucking the liquid which overflows in the first space and for supplying the liquid to pressure generating chambers which are paired with the jetting hole column and communicate with jetting holes.

According to the present invention, the liquid which overflows in the negative pressure chamber may be reused.

Further, as solving means related to the liquid jet recording apparatus, there is adopted means in which, in any one of the liquid jet recording apparatuses adopting the above-mentioned solving means, the reuse liquid supply system includes a filter portion or a deaerator.

According to the present invention, liquid in an appropriate state may be reused.

Further, as solving means related to a method of filling liquid into a liquid jet head, there is adopted means in which a method of filling liquid into a liquid jet head, the liquid jet head including: a jetting body guard for covering a periphery of the jetting hole column; the jetting body guard having a slit formed therein which is opposed to the jetting hole column; a suction flow path connected to a sucking portion for sucking the liquid which leaks from the jetting hole column; and a partitioning portion for partitioning first space inside the jetting body guard and second space to which a suction port of the suction flow path is open, the partitioning portion having at least one communication hole formed therein for communication between the first space and the second space, the first space and the second space being caused to be a first negative pressure chamber and a second negative pressure chamber, respectively, by the sucking portion connected to the suction flow path, the method sucking the liquid which overflows from the jetting holes in the first negative pressure chamber, the method includes, under a state in which the sucking portion causes the first negative pressure chamber and the second negative pressure chamber to be lower than atmospheric pressure, pressurized filling of the liquid into pressure generating chambers which are paired with the jetting hole column and communicate with the jetting holes with a use of the liquid supply system.

According to the present invention, compared with a case in which the suction port is open to the first space, excess liquid may be reliably prevented from leaking via the slit and the ability to collect excess liquid may be improved. Further, jetting of the liquid after the liquid is filled may also be stabilized. Further, because excess liquid may be collected inside the jetting body guard, space used for collecting excess liquid may be extremely small to improve the space factor of the liquid jet head. This may improve the flexibility in designing the liquid jet head.

Further, as solving means related to the method of filling liquid into a liquid jet head, there is adopted means in which the pressurized filling ends under a state in which the pressure in the first negative pressure chamber is caused to be lower than the atmospheric pressure by the sucking portion.

According to the present invention, because pressurized filling ends under a state in which the pressure in the first negative pressure chamber is caused to be lower than atmospheric pressure and because liquid does not flow out to the first negative pressure chamber, compared with a case in which pressurized filling into the pressure generating chambers ends after the pressure in the first space recovers, excess liquid is less liable to leak via the slit and also does not overflow from the slit. This enables filling of liquid while contamination with excess liquid is prevented, and jetting of the liquid after the liquid is filled may be stabilized.

Further, the method of filling liquid into a liquid jet head according to the present invention includes performing a liquid filling mode in which, by operating the sucking portion by first output, the first space is caused to become a negative pressure chamber and the liquid that leaks from the jetting hole column is sucked via the suction flow path.

According to the structure, by operating the sucking portion by the first output, the first space and the second space of the jetting body guard are caused to become a first negative pressure chamber and a second negative pressure chamber, respectively, in both of which the pressure is negative enough compared with atmospheric pressure. In this case, in initial filling of the liquid and in normal use, excess liquid which is supplied from a liquid supply portion and leaks from the jetting hole column flows out to the negative pressure chamber which communicates with the outside only via the slit, and gas outside the first negative pressure chamber and the second negative pressure chamber flows in the first negative pressure chamber via the slit. This causes excess liquid to move through the first negative pressure chamber under a state in which the excess liquid is hard to leak to the outside via the slit, to move through the second negative pressure chamber, and to be sucked from the suction port into the suction flow path to be discharged to the outside, and thus, liquid which flows out of the jetting hole column may be collected.

Therefore, excess liquid is prevented from leaking via the slit and initial filling of the liquid may be carried out.

Further, a method of filling liquid into a liquid jet head according to the present invention includes performing switching control carried out between a liquid filling mode in which, by operating the sucking portion by first output, the first space and the second space are caused to become the first negative pressure chamber and the second negative pressure chamber, respectively, and the liquid that leaks from the jetting hole column is sucked via the suction flow path and a normal use mode in which the sucking portion is operated by second output which is smaller than the first output and the liquid is jetted from the jetting hole column toward a recording medium to carry out recording on the recording medium.

According to the structure, in the normal operation mode, by operating the sucking portion by the second output which is smaller than the output in the liquid filling mode, even if excess liquid which leaks from the jetting holes in printing or the like or excess liquid which remains in the first space and the second space of the jetting body guard after the liquid is filled exists, excess liquid may be prevented from leaking via the slit by sucking the excess liquid. Therefore, under a state in which the direction of openings of the jetting holes is in the direction of gravity, from initial filling of liquid up to printing may be carried out without providing a service station.

### Effect of the Invention

According to the present invention, when gas in the second space is sucked, gas in the first space flows in the second space via the communication hole, and gas in the second space is sucked with the sucking portion from the suction port via the suction flow path, and hence the second space is depressurized to become a second negative pressure chamber.

When the second space becomes the second negative pressure chamber, gas in the first space flows in the second negative pressure chamber via the communication hole. Here, outside gas flows in the first space via the slit. By sucking the gas into the second negative pressure chamber via the first space, the first space is depressurized to become a first negative pressure chamber. Here, because gas flows in the second negative pressure chamber only from the first negative pressure chamber and via the communication hole, the extent of the negative pressure in the second negative pressure chamber is higher than that in the first negative pressure chamber.

With this, in initial filling of liquid or the like, excess liquid which leaks from the jetting hole column may be promptly sucked into the second negative pressure chamber from the communication hole in proximity thereto together with gas which flows in the second negative pressure chamber. Here, excess liquid sucked into the second negative pressure chamber moves through the second negative pressure chamber under a state in which the excess liquid is prevented from leaking from the communication hole to the first negative pressure chamber, and is sucked from the suction port into the suction flow path to be discharged to the outside. Therefore, compared with a case in which the suction port is open to the first space, excess liquid may be reliably prevented from leaking via the slit and the ability to collect excess liquid may be improved.

Therefore, contamination with excess liquid may be prevented with a simple structure and initial filling of the liquid jet head may be achieved without providing a complicated service station as in a conventional case. Accordingly, jetting of the liquid after the liquid is filled may also be stabilized. Further, because excess liquid may be collected inside the jetting body guard, space used for collecting excess liquid may be extremely small to improve the space factor of the liquid jet head. This may improve the flexibility in designing the liquid jet head.

### BRIEF DESCRIPTION OF THE DRAWINGS

FIG. 1 is a perspective view illustrating an ink jet recording apparatus according to an embodiment of the present invention.

FIG. 2 is a schematic structural view of the ink jet recording apparatus according to the embodiment of the present invention.

FIG. 3 is a perspective view of an ink jet head according to a first embodiment of the present invention.

FIG. 4 is a schematic structural view of the ink jet head viewed from a right side according to the first embodiment of the present invention.

FIG. 5 is a sectional view taken along the line I-I of FIG. 4.

FIG. 6 is an exploded perspective view of a head chip.

FIG. 7 is a sectional view taken along the line J-J of FIG. 4.

FIG. 8 is a sectional perspective view taken along the line K-K of FIG. 3.

FIG. 9 shows graphs of a relationship among operation timing of a suction pump, operation timing of a pressure pump, and first space and second space (first negative pressure chamber and second negative pressure chamber).

FIG. 10 are enlarged sectional views of a principal part of the head chip illustrating operation of initial filling.

FIG. 11 is a sectional view illustrating a principal part in a second embodiment of the present invention, which is an enlarged view corresponding to FIG. 5.

FIG. 12 is a sectional perspective view illustrating the second embodiment of the present invention, which corresponds to FIG. 8.

FIG. 13 is a schematic structural view of an ink jet head viewed from a right side according to a third embodiment of the present invention.

FIG. 14 is a sectional view of a principal part according to a fourth embodiment of the present invention, which is an enlarged view corresponding to FIG. 5.

FIG. 15 shows graphs of a relationship among operation timing of the suction pump, operation timing of the pressure pump, and the first space according to the embodiment of the present invention.

FIG. 16 are enlarged views of principal parts of ink jet heads illustrating modified examples of the ink jet head according to the embodiment of the present invention.

### BEST MODES FOR CARRYING OUT THE INVENTION

Next, embodiments of the present invention are described with reference to the attached drawings.

### First Embodiment

### (Liquid Jet Recording Apparatus)

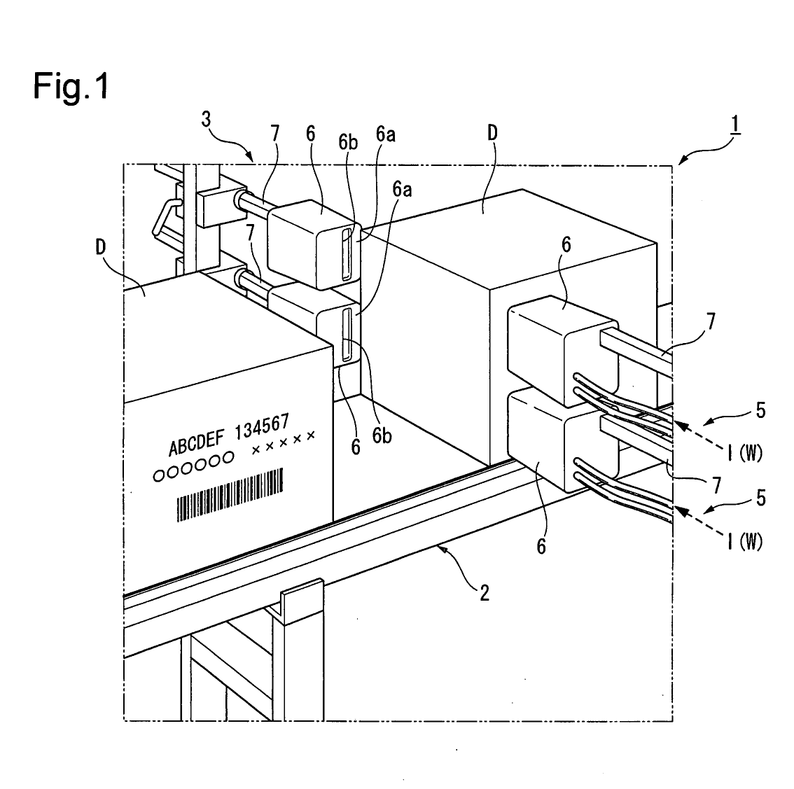

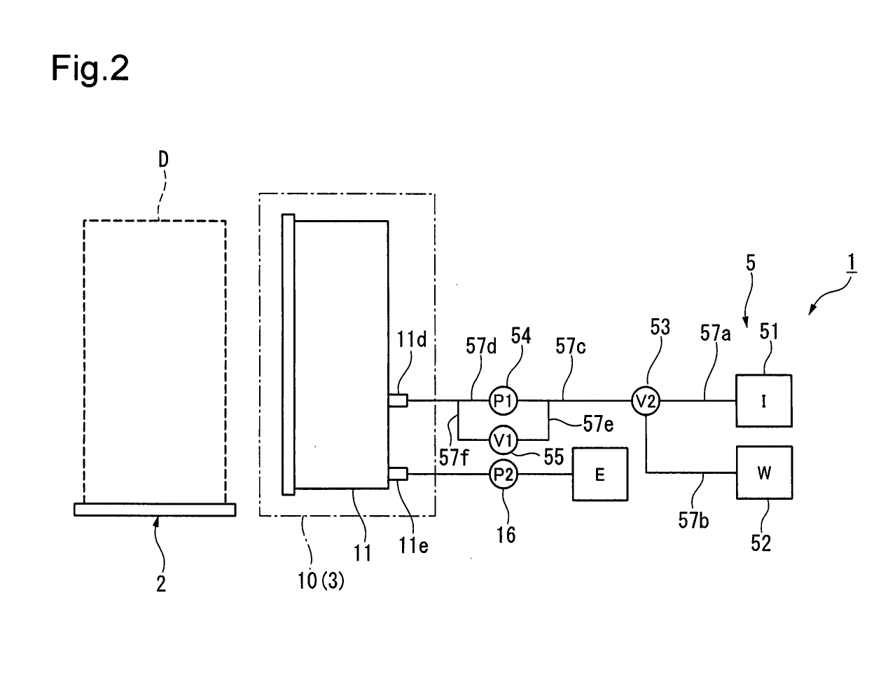

FIG. 1 is a perspective view illustrating an ink jet recording apparatus (liquid jet recording apparatus) 1 according to an embodiment of the present invention. FIG. 2 is a schematic structural view of the ink jet recording apparatus 1. The ink jet recording apparatus 1 is connected to a predetermined personal computer, and carries out printing on a box D by, based on print data sent from the personal computer, discharging (jetting) ink (liquid) I. The inkjet recording apparatus 1 includes a belt conveyor 2 for transferring the box D in one direction, an ink discharging portion 3 including a plurality of ink jet heads (liquid jet heads) 10, an ink supply portion 5 for, as illustrated in FIG. 2, supplying the ink I and a cleaning liquid W to the ink jet head 10, and a suction pump (sucking portion) 16 connected to the ink jet head 10.

The ink discharging portion 3 discharges the ink I to the box D, and, as illustrated in FIG. 1, includes four enclosures 6 in the shape of rectangular parallelepipeds. The ink jet heads 10 are placed in the enclosures 6, respectively (see FIG. 2). The enclosures 6 are disposed in pairs on both sides of the belt conveyor 2 in a width direction under a state in which ink discharge surfaces 6a thereof are oriented to the belt conveyor 2 side, respectively. Two of the enclosures 6 disposed on both sides of the belt conveyor 2 in the width direction are vertically aligned with the other two of the enclosures 6 and all the enclosures 6 are supported by support members 7, respectively. It is to be noted that an opening 6b is formed in the ink discharge surface 6a of the enclosure 6.

(Liquid Jet Head)

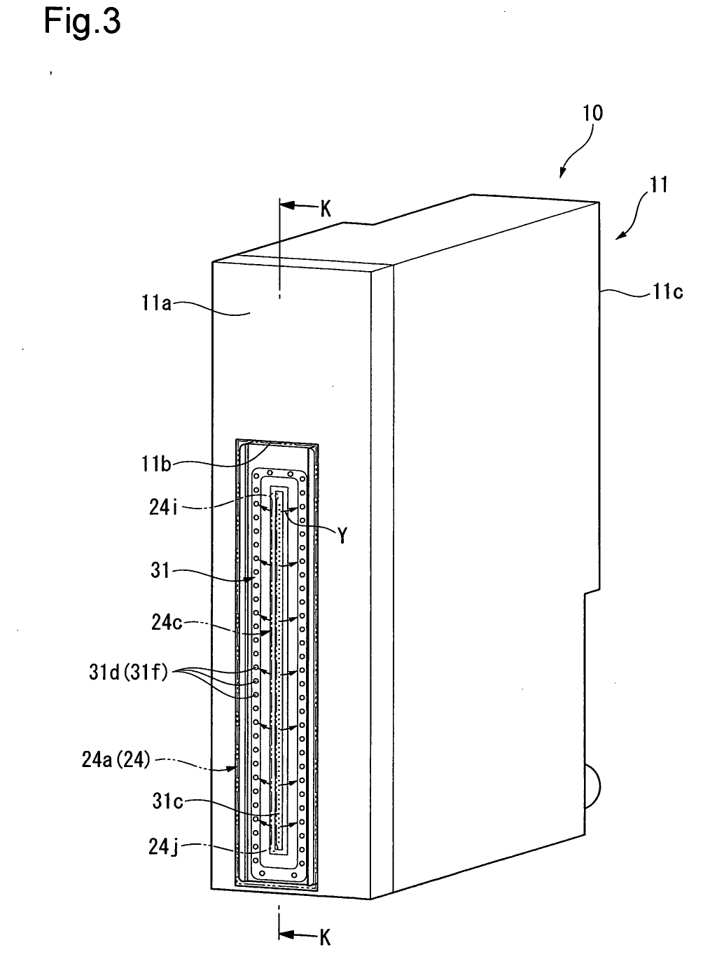

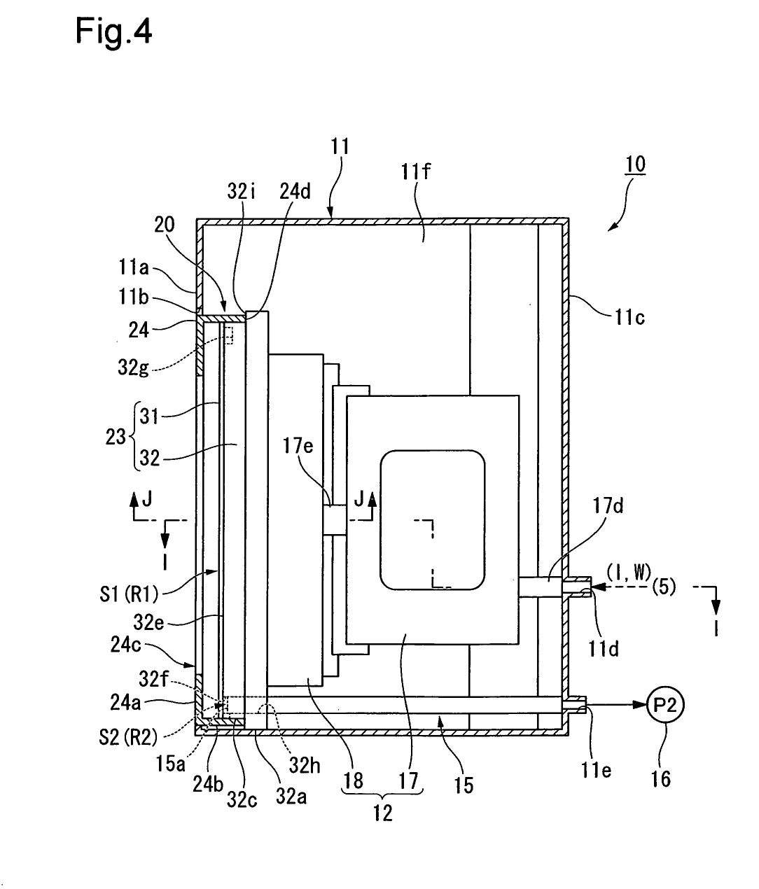

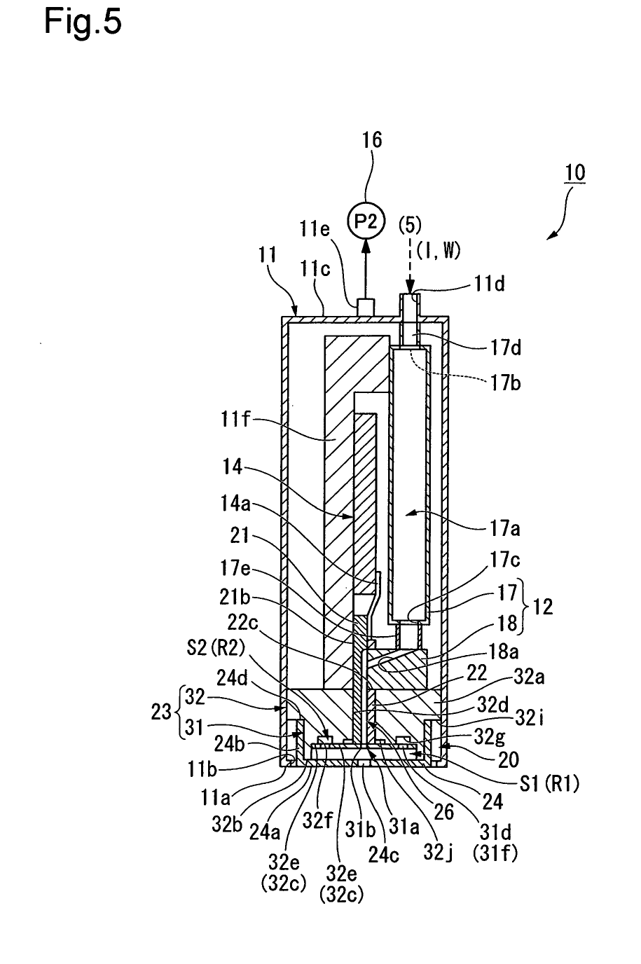

FIG. 3 is a perspective view of the ink jet head 10. FIG. 4 is a schematic structural view of the ink jet head 10 viewed from a right side. FIG. 5 is a sectional view taken along the line I-I of FIG. 4.

As illustrated in FIG. 4, the inkjet head 10 includes a case 11, a liquid supply system 12, a head chip 20, a drive circuit board 14 (see FIG. 5), and a suction flow path 15.

The case 11 is in the shape of a thin box with an exposure hole 11b formed in a lower portion of a front surface 11a thereof, and is fixed in the enclosure 6 with a thickness direction thereof being horizontal and with the exposure hole 11b oriented to the opening 6b. As illustrated in FIG. 4 and FIG. 5, through holes for communicating with internal space are formed in a back surface 11c of the case 11. More specifically, an ink injection hole 11d is formed in a substantially middle in a height direction, and an ink suction hole 11e is formed in a lower portion. The case 11 includes in the internal space thereof a base plate 11f fixed to the case 11 so as to be upright, and houses structural items of the ink jet head 10.

The liquid supply system 12 communicates with the ink supply portion 5 via the ink injection hole 11d, and substantially formed of a damper 17 and an ink flow path substrate 18.

As illustrated in FIG. 5, the damper 17 is for the purpose of adjusting pressure fluctuations of the ink I, and includes a storing chamber 17a for storing the ink I. The damper 17 is fixed to the base plate 11f and includes an ink intake hole 17b connected to the ink injection hole 11d via a tube member 17d and an ink outflow hole 17c connected to the ink flow path substrate 18 via a tube member 17e.

The ink flow path substrate 18 is, as illustrated in FIG. 4, a member formed so as to be vertically long, and, as illustrated in FIG. 5, a member having a circulation path 18a formed therein, which communicates with the damper 17 and through which the ink I passes, and is attached to the head chip 20.

As illustrated in FIG. 5, the drive circuit board 14 includes a control circuit (not shown) and a flexible substrate 14a. The drive circuit board 14 applies voltage to a ceramic piezoelectric plate (actuator) 21 according to a print pattern with one end of the flexible substrate 14a being joined to plate-like electrodes 28 to be described later and the other end being joined to a control circuit (not shown) on the drive circuit board 14. The drive circuit board 14 is fixed to the base plate 11f.

(Head Chip)

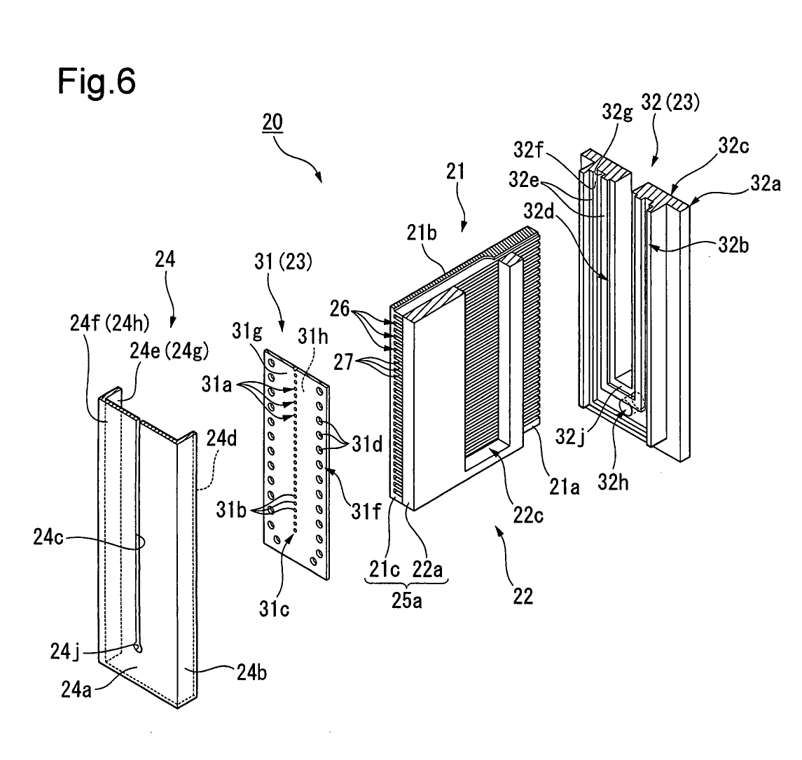

FIG. 6 is an exploded perspective view of the head chip 20.

As illustrated in FIG. 6, the head chip 20 includes the ceramic piezoelectric plate 21, the ink chamber plate 22, a nozzle body 23, and a nozzle guard (jetting body guard) 24.

The ceramic piezoelectric plate 21 is a substantially rectangular plate-like member formed of lead zirconate titanate (PZT) and has a plurality of long grooves 26 provided on one plate surface 21a of two plate surfaces 21a and 21b thereof so as to be stacked on top of one another, and the respective long grooves 26 are isolated from one another by side walls 27.

The long grooves 26 are provided so as to extend in a direction of a short side of the ceramic piezoelectric plate 21, and the plurality of long grooves 26 are provided so as to be stacked on top of one another over the whole length in a direction of a long side of the ceramic piezoelectric plate 21. The plurality of side walls 27 are provided so as to be stacked on top of one another over the long side of the ceramic piezoelectric plate 21 for partitioning into the long grooves 26. Plate-like electrodes (not shown) for applying drive voltage are provided on an opening side of the long grooves 26 of both wall surfaces of the side walls 27 (on a plate surface 21a side) so as to extend in the direction of the short side of the ceramic piezoelectric plate 21. The flexible substrate 14a described above is joined to the plate-like electrodes.

As illustrated in FIG. 5, a portion of the plate surface 21b on the back side surface side of the ceramic piezoelectric plate 21 is fixed to an edge portion of the base plate 11f, and the long grooves 26 extend toward the exposure hole 11b.

Further, the ink chamber plate 22 is, similarly to the ceramic piezoelectric plate 21, a substantially rectangular plate-like member. Compared with the size of the ceramic piezoelectric plate 21, the ink chamber plate 22 is formed so that its size in the direction of the long side is substantially the same as that of the ceramic piezoelectric plate 21 and its size in the direction of the short side is smaller than that of the ceramic piezoelectric plate 21. The ink chamber plate 22 includes an open hole 22c which passes through the thickness and which is formed over the long side of the ink chamber plate 22.

The ink chamber plate 22 is joined to the ceramic piezoelectric plate 21 from the plate surface 21a side so that a front side surface 22a thereof and the front side surface 21c of the ceramic piezoelectric plate 21 are flush with each other and form an abutting surface 25a. In this joined state, the open hole 22c exposes the whole of the plurality of long grooves 26 of the ceramic piezoelectric plate 21, all the long grooves 26 are open to the outside, and the respective long grooves 26 are in a communicating state.

As illustrated in FIG. 5, the ink flow path substrate 18 is attached to the ink chamber plate 22 so as to cover the open hole 22c. The circulation path 18a in the ink flow path substrate 18 communicates with the respective long grooves 26.

As illustrated in FIG. 5, the nozzle body 23 is formed by sticking a nozzle plate 31 to a nozzle cap 32.

As illustrated in FIG. 6, the nozzle plate 31 is a thin-plate-like (for example, 50 μm of thickness), strip-like member formed of polyimide, and a plurality of nozzle holes 31a which pass through the thickness thereof line up to form a nozzle column 31c. More specifically, the nozzle holes 31a the number of which is the same as that of the long grooves 26 are formed in line at the middle portion in the direction of the short side of the nozzle plate 31 at the same intervals as those of the long grooves 26. It is to be noted that a water-repellent film which is water-repellent for the purpose of preventing adhesion of ink and the like is applied to, of two plate surfaces of the nozzle plate 31, a plate surface to which orifices 31b for discharging the ink I is open, while the other plate surface is a surface to which the abutting surface 25a and the nozzle cap 32 are joined.

It is to be noted that the nozzle holes 31a are formed using an excimer laser.

Here, a plurality of communication holes 31d which pass through the thickness are formed in an outer peripheral portion of the nozzle plate 31. The communication holes 31d are circular holes formed so as to be a little larger than the inner diameter of the nozzle holes 31a described above, and are disposed so as to surround the nozzle column 31c at a pitch which is a little larger than that of the nozzle holes 31a. More specifically, the communication holes 31d are disposed so as to be in parallel with the nozzle column 31c on both sides of the nozzle column 31c, so as to be orthogonal to the nozzle column 31c above the nozzle column 31c, and so as to avoid a location opposed to a suction port 15a to be described later and so as to be orthogonal to the nozzle column 31c below the nozzle column 31c. In other words, a communication hole group 31f of a plurality of communication holes arranged so as to be in the shape of a ring is formed in the outer peripheral portion of the nozzle plate 31.

As illustrated in FIGS. 5 and 6, the nozzle cap 32 is a member in the shape of a frame-plate-like member with an outer periphery of one of two frame surfaces being cut away, and includes a thin-plate-like outer frame portion 32a, a middle frame portion 32b which is inside the outer frame portion 32a and which is formed so as to be thicker than the outer frame portion 32a, an inner frame portion 32c which is formed so as to be thinner than the middle frame portion 32b, and a long hole 32d which passes through the thickness at the middle portion in the direction of the short side of the inner frame portion 32c and which extends in the direction of the long side.

The outer frame portion 32a is formed so as to be thinner than the middle frame portion 32b and the inner frame portion 32c, and is formed in the shape of a handguard over the whole outer periphery of the nozzle cap 32.

A pair of the middle frame portions 32b are formed on both sides of the inner frame portion 32c in the direction of a short side, and extend so as to be in parallel with each other in the direction of a long side of the nozzle cap 32 and so as to protrude higher than an inner frame surface 32e of the inner frame portion 32c in a thickness direction. More specifically, on both sides in the direction of the long side of the nozzle cap 32, the middle frame portions 32b are not formed and are in an open state.

A groove portion 32f which is deeper than the inner frame surface (sticking surface) 32e in the thickness direction is formed in the inner frame surface (sticking surface) 32e of the inner frame portion 32c. The groove portion 32f is formed so as to surround the long hole 32d over the whole periphery of the inner frame surface 32e. A discharge hole 32h which passes through the thickness is formed in a bottom portion 32g of the groove portion 32f in a lower portion of the nozzle cap 32.

The nozzle plate 31 is stuck onto the inner frame surface 32e so as to block the long hole 32d and the groove portion 32f. A ring-shaped end portion 24d of the nozzle guard 24 is in abutting contact with an outer frame surface 32i of the outer frame portion 32a.

The nozzle body 23 is housed in the internal space of the case 11 so that the discharge hole 32h of the nozzle cap 32 is located on a lower side (see FIG. 3), and is fixed to the case 11 and the base plate 11f (see FIG. 5).

In this state, a part of the ceramic piezoelectric plate 21 and a part of the ink chamber plate 22 are inserted in the long hole 32d and the nozzle plate 31 is in abutment with the abutting surface 25a. Further, the nozzle plate 31 is formed so as to be equal to the outer shape of the inner frame surface 32e and the nozzle plate 31 is disposed on the whole surface of the inner frame surface 32e. More specifically, the nozzle plate 31 is adhered to the inner frame surface 32e by an adhesive under a state in which the communication hole group 31f is opposed to the groove portion 32f in the nozzle cap 32. Both sides in the direction of the short side of the nozzle plate 31 are in contact with opposing surfaces of the pair of the middle frame portions 32b while both sides in the direction of a long side of the nozzle plate 31 are in contact with an inner surface 24e of the nozzle guard 24. Therefore, the groove portion 32f is covered with the nozzle plate 31, and communicates with the side of a surface (hereinafter referred to as front surface 31g) which is opposite to a surface (hereinafter referred to as rear surface 31h) adhered to the inner frame surface 32e of the nozzle plate 31 only via the communication hole group 31f. Space surrounded by the nozzle plate 31 and the groove portion 32f forms second space S2.

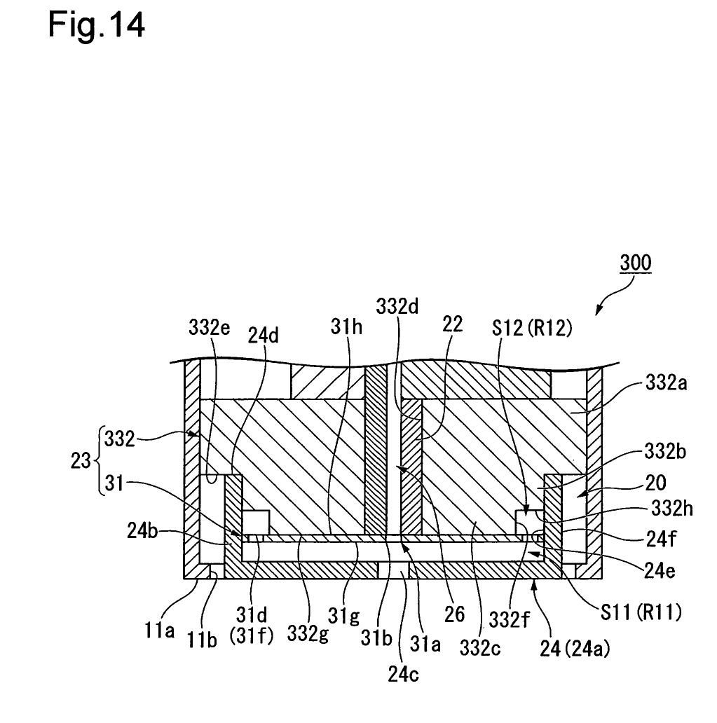

It is to be noted that, when a part of the ceramic piezoelectric plate 21 and a part of the ink chamber plate 22 are inserted in the above-mentioned long hole 32d, and in a step of adhering the nozzle plate 31 to the joined body, an adhesive is used to carry out fixing. In this adhering and fixing step, if only a small amount of the adhesive is used, there is a possibility of adhesion failure, and thus, the adhering is carried out with a sufficiently large amount of the adhesive. Further, in this case, when, for example, an excess adhesive flows in the long grooves 26, the volumes in the long grooves 26 become smaller, and hence there is a possibility that the amount of ink which can be discharged becomes smaller and discharge failure is caused. As a structure which avoids such a case, as illustrated in FIGS. 5 and 6, an adhesive flow groove 32j is provided at the edge of the opening of the long hole 32d in the nozzle cap 32 in this embodiment. It is to be noted that, because the adhesive flow groove 32j is at a place at which the nozzle cap 32, the ceramic piezoelectric plate 21, the ink chamber plate 22, and the nozzle plate 31 are joined together, by adopting this structure, an excess adhesive can be effectively removed. However, the adhesive flow groove 32j is not an indispensable groove portion, and, for example, a structure without the adhesive flow groove as in an embodiment described later with reference to FIG. 14 is also possible.

In such a structure, when a predetermined amount of the ink I is supplied from the storing chamber 17a in the damper 17 to the ink flow path substrate 18, the supplied ink I is fed via the open hole 22c into the long grooves 26.

(Nozzle Guard)

As illustrated in FIGS. 4 to 6, the nozzle guard 24 is a member substantially in the shape of a box formed of stainless steel or the like, and is formed by press forming. The nozzle guard 24 includes a top plate portion 24a formed so as to be rectangular-plate-like, and an airtight portion 24b which extends from a peripheral portion of the top plate portion 24a in a direction substantially orthogonal to a surface of the plate.

The top plate portion 24a includes at the middle portion in the direction of a short side thereof a slit 24c which extends in the direction of a long side thereof. The slit 24c is formed so as to be a little longer than the nozzle column 31c, and both end portions (upper end portion 24i and lower end portion 24j) thereof are formed in the shape of a circle.

The width dimension of the slit 24c is set to be about 1.5 mm while the nozzle diameter of the nozzle holes 31a is 40 μm. The width dimension of the slit 24c is desirably set so that the upper limit thereof is the largest size at which the suction pump 16 can generate negative pressure and the lower limit thereof is the smallest size at which, in the initial filling of the ink I, the ink I does not overflow from the slit 24c to droop. It is to be noted that the upper end portion 24i and the lower end portion 24j are formed in the shape of a circle the diameter of which is a little larger than the above-mentioned width dimension.

As illustrated in FIG. 6, a hydrophilic film 24g is formed by titanium coating on an inward inner surface 24e of the nozzle guard 24, while a water-repellent film 24h is formed by fluorine resin coating or Teflon (registered trademark) plating on an outer surface 24f on a back surface of the inner surface 24e and on an inner surface of the slit 24c.

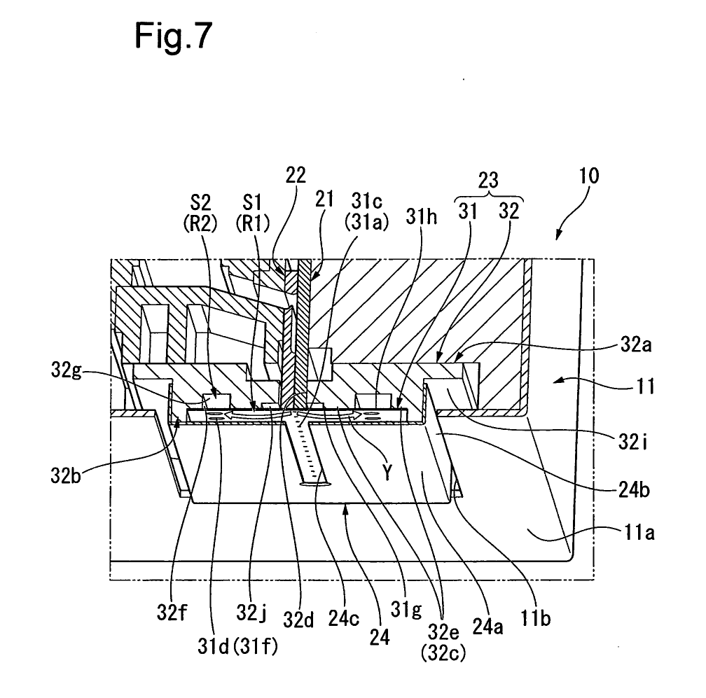

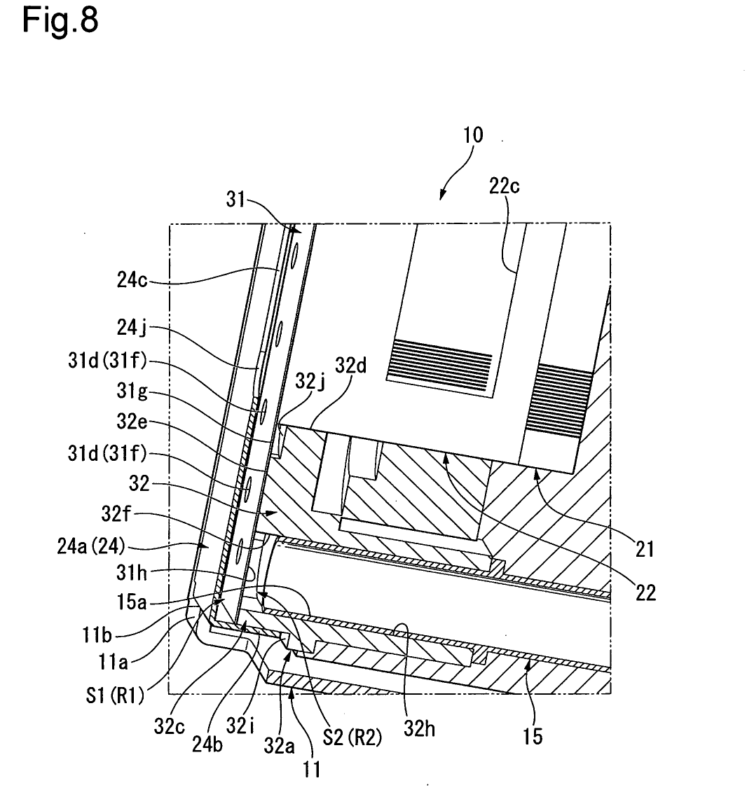

FIG. 7 is a sectional view taken along the line J-J of FIG. 4, and FIG. 8 is a sectional perspective view taken along the line K-K of FIG. 3.

Here, as illustrated in FIGS. 7 and 8, the nozzle guard 24 is disposed so that the top plate portion 24a covers the inner frame portion 32c, the groove portion 32f, and the discharge hole 32h in the nozzle cap 32. Further, the ring-shaped end portion 24d is adhered to the outer frame surface 32i with an adhesive under a state in which the inner surface 24e in the direction of a long side of the airtight portion 24b is in contact with side surfaces of the middle frame portions 32b and under a state in which the inner surface 24e in the width direction is in contact with side surfaces of the inner frame portion 32c, and the nozzle guard 24 is attached to the nozzle cap 32 so as to cover the nozzle cap 32.

In this state, the slit 24c is opposed to the nozzle column 31c but not opposed to the discharge hole 32h. Inside space of the nozzle guard 24, more specifically, space between the nozzle guard 24 and the nozzle plate 31 forms first space S1 to which the nozzle holes 31a and the slit 24c are open. More specifically, the inside space of the nozzle guard 24 is partitioned by the nozzle plate 31, and the first space S1 is formed on the front surface 31g side (ink discharge side) of the nozzle plate 31 while the above-mentioned second space S2 is formed on the rear surface 31h side. The first space S1 and the second space S2 communicate with each other only via the communication hole group 31f formed in the nozzle plate 31. It is to be noted that the distance between the top plate portion 24a of the nozzle guard 24 and the nozzle plate 31 is desirably set so that the upper limit thereof is the largest distance at which the suction pump 16 can generate negative pressure and the lower limit thereof is the smallest distance at which, in the initial filling of the ink I, the ink I does not overflow from the slit 24c.

As illustrated in FIGS. 4 and 8, the above-mentioned suction flow path 15 is formed by fitting and inserting one end of a tube to be the suction port 15a in the discharge hole 32h to be fixed and connecting the other end to the ink suction hole 11e. Therefore, the suction port 15a is open to a location which is not opposed to the communication holes 31d in the nozzle plate 31 and which is not opposed to the slit 24c. Therefore, the suction port 15a is open to the second space S2 under a state of being completely covered with the nozzle plate 31.

Further, the suction pump 16 is connected to the ink suction hole 11e via a tube. In operation, the suction pump 16 sucks air and the ink I in the space S1 and the space S2 to cause the space S1 and the space S2 to become negative pressure chambers R1 and R2, respectively. It is to be noted that the suction pump 16 stores the sucked ink I in a waste liquid tank E (see FIG. 2). Further, the suction pump 16 may be mounted on the ink jet head 10, or, as in this embodiment, may be separate and included on the ink jet recording apparatus. In this embodiment, because the suction pump 16 is provided on the apparatus side, it is not necessary to attach the suction pump 16 on the ink jet head 10 side, which enables simplification of the structure of the ink jet head 10 and miniaturization of the ink jet head 10.

Reference is made again to FIG. 2. The ink supply portion 5 includes an ink tank 51 in which the ink I is stored, a cleaning liquid tank 52 in which the cleaning liquid W is stored, a changeover valve 53 which can switch between two flow paths, a pressure pump 54 which supplies the ink I or the cleaning liquid W to the ink jet head 10 in a pressurized state, and an open/close valve 55 which can open and close the flow paths.

The ink tank 51 and the cleaning liquid tank 52 communicate with the pressure pump 54 via a supply tube 57a, the changeover valve 53, and a supply tube 57c, and via a supply tube 57b, the changeover valve 53, and the supply tube 57c, respectively. More specifically, the supply tubes 57a and 57b as inflow tubes and the supply tube 57c as an outflow tube are connected to the changeover valve 53.

The pressure pump 54 is connected to the supply tube 57c and communicates with the ink jet head 10 via a supply tube 57d, and supplies the ink I or the cleaning liquid W, which flows in from the supply tube 57c, to the ink jet head 10. The pressure pump 54 is formed not to allow fluid to flow therethrough in a non-operating state, and has a function like an open/close valve.

The open/close valve 55 is connected to a supply tube 57e which communicates with the supply tube 57c to be an inflow tube and to a supply tube 57f which communicates with the supply tube 57d to be an outflow tube. More specifically, when the open/close valve 55 is opened, the supply tubes 57e and 57f function as a bypass of the pressure pump 54.

Next, operation of the ink jet recording apparatus 1 structured as described above is described.

### (Initial Filling of Ink)

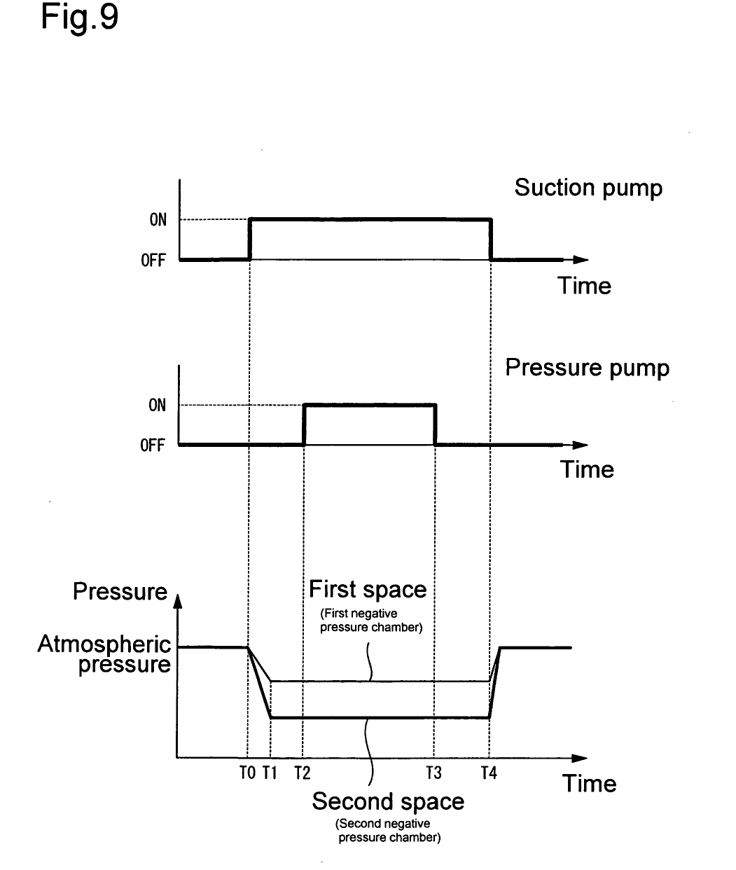

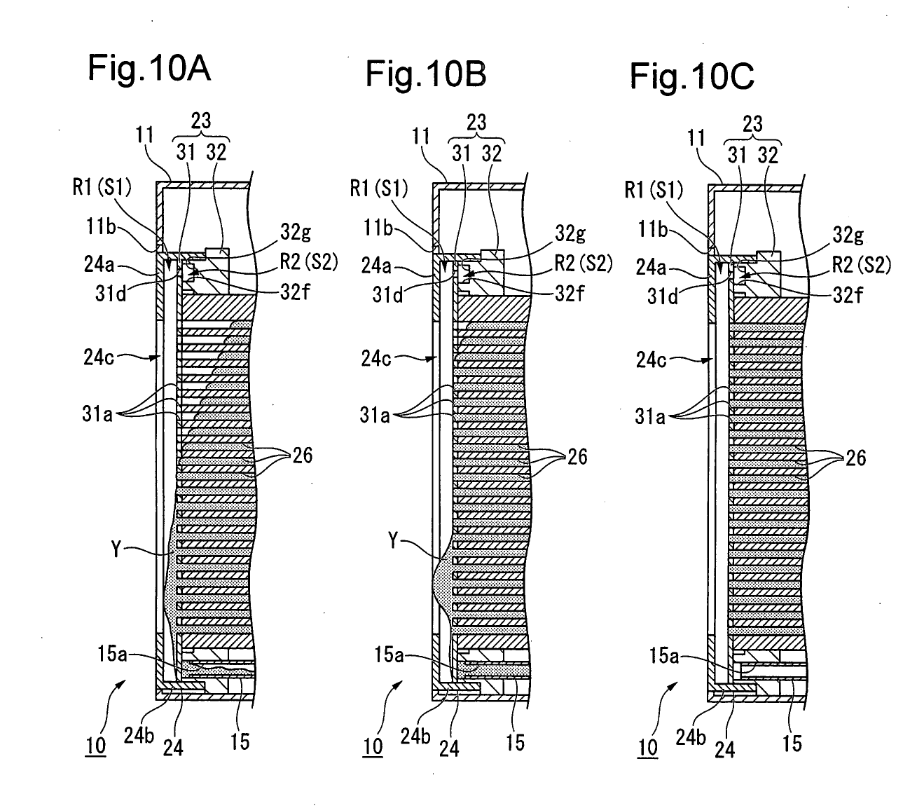

FIG. 9 shows graphs of a relationship among operation timing of the suction pump 16, operation timing of the pressure pump 54, and the first space S1 and the second space S2 (first negative pressure chamber R1 and second negative pressure chamber R2). FIGS. 10 are enlarged sectional views of a principal part of the head chip 20 illustrating operation of initial filling.

First, as illustrated in FIG. 4 and FIG. 9, the suction pump 16 of the ink jet head 10 is operated and the suction pump 16 sucks air in the second space S2 from the suction port 15a via the suction flow path 15 (at time T0 of FIG. 9). Here, air in the first space S1 flows in the second space S2 via the communication holes 31d. By sucking air in the second space S2 from the suction port 15a via the suction flow path 15 with the suction pump 16, the second space S2 is depressurized. After a predetermined time passes, at T1, the second space S2 becomes the second negative pressure chamber R2 in which the pressure becomes negative enough compared with atmospheric pressure.

When the second space S2 becomes the second negative pressure chamber R2, as described above, air in the first space S1 flows in the second negative pressure chamber R2 via the communication hole group 31f in the nozzle plate 31. Here, outside air flows in the first space S1 via the slit 24c. By sucking the air into the second negative pressure chamber R2 via the first space S1, the first space S1 is depressurized to become the first negative pressure chamber R1 in which the pressure becomes negative enough compared with atmospheric pressure. Air which flows from the first negative pressure chamber R1 via the communication hole group 31f in the second negative pressure chamber R2 is, as described above, sucked with the suction pump 16 via the suction flow path 15. Here, the second negative pressure chamber R2 is covered with the nozzle plate 31 and communicates with the first negative pressure chamber R1 only via the communication hole group 31f, and air flows in the second negative pressure chamber R2 only via the communication hole group 31f, and thus, the extent of the negative pressure in the second negative pressure chamber R2 is higher than that in the first negative pressure chamber R1.

After the spaces S1 and S2 become the negative pressure chambers R1 and R2, respectively, the ink supply portion 5 carries out pressurized filling of the ink I into the ink jet head 10 (at time T2 of FIG. 9). Here, the ink supply portion 5 is set as in the following. That is, as illustrated in FIG. 2, the changeover valve 53 communicates the supply tube 57a and the supply tube 57c with each other, and the open/close valve 55 is closed to interrupt the communication between the supply tube 57e and the supply tube 57f. With this state being kept, the pressure pump 54 is activated. The pressure pump 54 injects the ink I from the ink tank 51 via the supply tubes 57a, 57c, and 57d into the ink injection hole 11d of the ink jet head 10.

As illustrated in FIG. 4 and FIG. 5, the ink I injected into the ink injection hole 11d flows in the storing chamber 17a via the ink intake hole 17b in the damper 17, and then, flows out to the circulation path 18a in the ink flow path substrate 18 via the ink outflow hole 17c. Then, the ink I which flows in the circulation path 18a flows in the respective long grooves 26 via the open hole 22c.

The ink I which flows in the respective long grooves 26 flows to the nozzle holes 31a side, and, after reaching the nozzle holes 31a, as illustrated in FIGS. 3 and 7, flows out of the nozzle holes 31a as excess ink Y. Here, the excess ink Y is promptly sucked from the communication holes 31d in proximity thereto into the second negative pressure chamber R2 together with air which is sucked into the second negative pressure chamber R2 via the communication hole group 31f (see arrows Y of FIGS. 3 and 7).

Then, the excess ink Y sucked into the second negative pressure chamber R2 is guided into the groove portion 32f in the second negative pressure chamber R2, and flows downward in the groove portion 32f to be discharged from the suction port 15a to the waste liquid tank E. This enables continuous and reliable suction of the excess ink Y absorbed in the second negative pressure chamber R2. In this case, because the groove portion 32f is formed so as to surround the whole periphery of the nozzle plate 31, air passes uniformly through the whole periphery of the second negative pressure chamber R2, and the second negative pressure chamber R2 becomes uniform negative pressure space. This enables prompt suction of the excess ink Y which leaks in the first negative pressure chamber R1 from the communication holes 31d in proximity thereto, and the ability to collect the excess ink Y can be improved.

By the way, in the event that the amount of the excess ink Y which flows out is large, as illustrated in FIG. 10A, the excess ink Y flows down not only on the nozzle plate 31 but also on the inner surface 24e of the nozzle guard 24. Here, air continuously flows in the first negative pressure chamber R1 via the slit 24c, and thus, the excess ink Y may be prevented from leaking to the outside via the slit 24c. As illustrated in FIG. 10B, supposing the amount of the excess ink Y which flows on the inner surface 24e in proximity to the slit 24c becomes 24c becomes locally large and a part of the excess ink Y reaches the vicinity of the outer surface 24f against air which flows in via the slit 24c, the excess ink Y is repelled by the water-repellent film 24h formed on the outer surface 24f. The repelled ink I is guided by the hydrophilic film 24g formed on the inner surface 24e and returns to the first negative pressure chamber R1 again.

Further, in the lower end portion 24j of the slit 24c, surface tension acts on the ink I at the contour of a circular lower end portion 24j (at the boundary between the outer surface 24f and the lower end portion 24j). In the lower end portion 24j, strong surface tension acts on the ink I and the balance of the surface tension is kept, and thus, the surface of the ink I is not broken and the ink I does not leak to the outside. Further, similarly to the case described above, the ink I is guided by the water-repellent film 24h formed on the outer surface 24f and the hydrophilic film 24g formed on the inner surface 24e to be returned to the first negative pressure chamber R1. The excess ink Y which returns to the first negative pressure chamber R1 is similarly discharged from the suction port 15a via the second negative pressure chamber R2 to the waste liquid tank E.

In this way, the excess ink Y which leaks from of the nozzle holes 31a is continuously discharged to the waste liquid tank E.

As illustrated in FIG. 9, after a predetermined time passes, at T3, the pressure pump 54 is stopped to end the pressurized filling of the ink I. In association with the stop of the pressure pump 54, the excess ink Y no longer flows out of the nozzle holes 31a, and the excess ink Y which remains in the first negative pressure chamber R1 is sucked into the second negative pressure chamber R2 via the communication hole group 31f, and the excess ink Y sucked in the second negative pressure chamber R2 is discharged to the waste liquid tank E via the suction port 15a.

Then, after a predetermined time passes, at T4, the suction pump 16 is stopped. After the filling of the ink I is completed, as illustrated in FIG. 10C, the long grooves 26 are filled with the ink I. It is to be noted that the pressure in each of the spaces S1 and S2 recovers to be atmospheric pressure again (see FIG. 9).

(In Printing)

Next, operation when printing is carried out on the box D is described. First, setting of the ink supply portion 5 is described. That is, as illustrated in FIG. 2, the supply tube 57a and the supply tube 57c are caused to communicate with each other by the changeover valve 53, and the open/close valve 55 is opened to communicate the supply tube 57e and the supply tube 57f with each other. With this state being kept, the pressure pump 54 is inactivated so that the supply tube 57c and the supply tube 57d do not communicate with each other via the pressure pump 54. In this state, the ink I is injected via the supply tubes 57a, 57c, 57e, 57f, and 57d into the ink injection hole lid of the ink jet head 10.

The belt conveyor 2 is driven in a state in which the ink supply portion 5 is set as described above (see FIG. 1), the box D is transferred in one direction, and, when the transferred box D passes in front of the enclosures 6, that is, passes in front of the nozzle plates 31 (nozzle holes 31a), the ink discharging portions 3 discharge ink droplets toward the box D.

More specifically, based on print data which is input from an outside personal computer, the drive circuit board 14 selectively applies voltage to predetermined plate-like electrodes 28 correspondingly to the print data. This reduces the capacities of the long grooves 26 corresponding to the plate-like electrodes 28, and the ink I filled into the long grooves 26 is discharged from the orifices 31b toward the box D.

When the ink I is discharged, the long grooves 26 are under negative pressure, and thus, the ink I is filled into the long grooves 26 via the above-mentioned supply tubes 57a, 57c, 57e, 57f, and 57d.

In this way, the ceramic piezoelectric plate 21 of the ink jet head 10 is driven according to the image data, and ink droplets are discharged from the nozzle holes 31a to land on the box D. In this way, by continually discharging ink droplets from the ink jet head 10 while the box D is moved, an image (text) is printed on desired locations of the box D.

In this way, in this embodiment, the inside space of the nozzle guard 24 is partitioned into the first space S1 and the second space S2, and the first space S1 and the second space S2 are communicated with each other via the communication hole group 31f in the nozzle plate 31.

According to the structure, because, in initial filling of the ink I or the like, the inside space of the nozzle guard 24 is partitioned into the first negative pressure chamber R1 and the second negative pressure chamber R2 the extent of the negative pressure in which is higher than that in the first negative pressure chamber R1, the excess ink Y which leaks from the nozzle holes 31a can be sucked into the second negative pressure chamber R2 together with gas which flows in the second negative pressure chamber R2. Here, the excess ink Y sucked into the second negative pressure chamber R2 moves through the second negative pressure chamber R2 under a state in which the excess ink Y is prevented from leaking to the first negative pressure chamber R1 via the communication holes 31d and is sucked from the suction port 15a into the suction flow path 15 to be discharged to the outside. Therefore, compared with a case in which the suction port 15a is open to the first space S1, the excess ink Y can be reliably prevented from leaking via the slit 24c to further improve the ability to collect the excess ink Y.

Further, according to the structure, the first negative pressure chamber R1 is in a negative pressure state and the extent of the negative pressure in the second negative pressure chamber R2 is higher than that in the first negative pressure chamber R1. This causes the excess ink Y to be, when the excess ink Y flows out of the nozzle holes 31a, guided to the communication holes 31d by the negative pressure in the first negative pressure chamber R1, and further, guided to the second negative pressure chamber R2 the extent of the negative pressure kept by which is higher than that kept by the first negative pressure chamber R1. More specifically, by the structure in which the nozzle plate 31 is spread between the slit 24c and the discharge hole 32h and the first negative pressure chamber R1 and second negative pressure chamber R2 are provided, the excess ink Y can be discharged more reliably.

Therefore, contamination with the excess ink Y may be prevented with a simple structure and initial filling of the ink jet head 10 may be achieved without providing a complicated service station as in a conventional case. Accordingly, jetting of the liquid after the ink I is filled may also be stabilized. Further, because the excess ink Y may be collected inside the nozzle guard 24, space used for collecting the excess ink Y may be extremely small to improve the space factor of the ink jet head 10. This may improve the flexibility in designing the ink jet head.

Here, by forming the second space S2 between the groove portion 32f in the nozzle cap 32 and the nozzle plate 31, the nozzle plate 31 is caused to function as a partitioning portion and the second space S2 is formed in the inside space of the nozzle guard 24. Therefore, the space factor of the ink jet head 10 may be improved with a simple structure.

Further, by partitioning the inside space of the nozzle guard 24 by the nozzle plate 31 and forming the communication holes 31d in the nozzle plate 31, it is not necessary to separately provide a member for partitioning the inside space into the first space S1 and the second space S2, and thus, the number of parts and the manufacturing cost can be reduced.

Further, by disposing the communication holes 31d and the suction port 15a so as not to be opposed to each other, air which flows in the second negative pressure chamber R2 via the first negative pressure chamber R1 does not directly reach the suction port 15a but reaches the suction port 15a after passing through the second negative pressure chamber R2, and thus the negative pressure state in the second negative pressure chamber R2 can be kept satisfactory. This enables prompt collection of the excess ink Y.

Here, in the ink jet head 10 according to this embodiment, the arrangement of the nozzle column 31c is in the direction of gravity and the openings of the nozzle holes 31a are in the horizontal direction, but the present invention is not limited thereto. A structure in which the openings of the nozzle holes 31a are in the direction of gravity and the nozzle column 31c extends in the horizontal direction is also possible.

In such a case, because the openings of the orifices 31b of the nozzle holes 31a is in the direction of gravity, there is a case in which the excess ink Y which leaks from the nozzle holes 31a when the ink I is filled is not completely sucked and remains in a border portion between the top plate portion 24a of the nozzle guard 24 and the peripheral wall portion 24b or the like. Further, there is a possibility that, after the ink I is filled, for example, in printing, the excess ink Y leaks from the nozzle holes 31a.

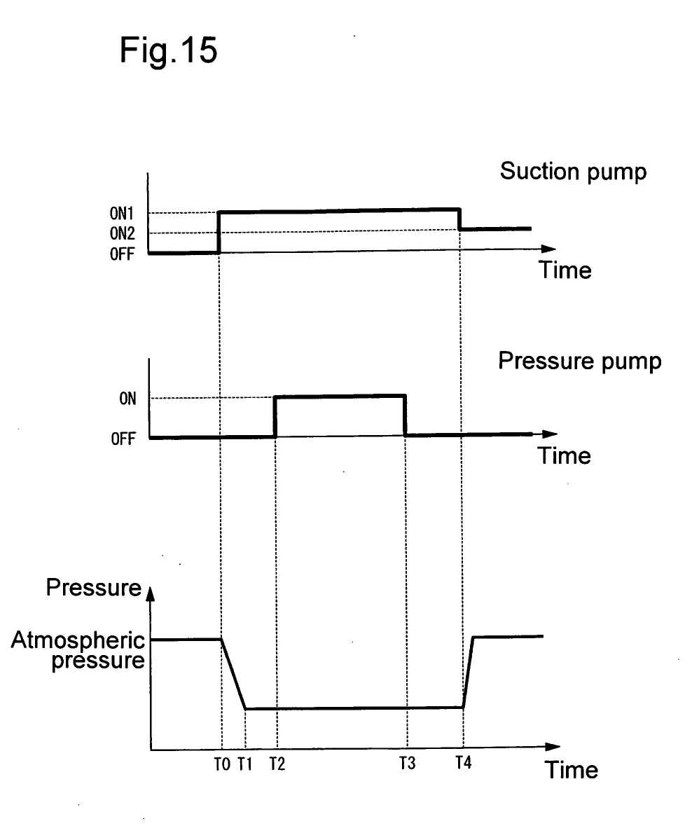

As an example to solve such an event, as illustrated in FIG. 4 and FIG. 15, the suction pump 16 is activated (ON1), and the suction pump 16 sucks air in the first space S1 from the suction port 15a via the suction flow path 15 (at time T0 of FIG. 15). It is to be noted that, for the sake of simplicity, in this example, the description is with regard to the first space S1 and the first negative pressure chamber R1. Here, it is preferred that the output of the operating suction pump 16 be set so as to cause the pressure in the first space S1 to be negative enough, and the output here is filling output of the suction pump 16. When the suction pump 16 is activated by the filling output (first output), outside air flows from the slit 24c in the first space S1. By sucking the air after the air passes through the first space S1 and reaches the suction port 15a, the first space S1 is depressurized (liquid filling mode). After a predetermined time passes, at T1, the first space S1 becomes the first negative pressure chamber R1 in which the pressure is negative enough compared with atmospheric pressure.

Therefore, as illustrated in FIG. 15, in this embodiment, even after the ink I is filled, the suction pump 16 is operated all the time (ON2 of FIG. 15). Here, the output of the suction pump 16 is set so as to be smaller than the output (filling output) when the ink I is filled and so that, in printing, the excess ink Y existing in the first space S1 can be sufficiently sucked (normal use mode). This causes the first space S1 to be space the extent of the negative pressure of which is lower than that when the ink I is filled. It is to be noted that, when the output of the suction pump 16 is too large, the trajectories of ink droplets discharged from the nozzle holes 31a in printing are affected, and there is a possibility that the printing precision is affected, which is not preferred. The output of the suction pump 16 here is referred to as normal output (second output).

By carrying out printing under a state in which the suction pump 16 is operated by the normal output, the excess ink Y which leaks from the nozzle holes 31a and the excess ink Y which remains on the inner surface 24e of the nozzle guard 24 flow toward the suction flow path 15. The ink I which reaches the suction flow path 15 is sucked into the suction flow path 15 to be discharged to the waste liquid tank E.

It is to be noted that operation of ON2 described as the normal use mode of FIG. 15 is not necessarily required to be carried out together with operation of ON1 of FIG. 15 described as the liquid filling mode described above, and may be appropriately carried out depending on the operation environment and the kind of the ink I.

Further, in this example, the description is made focusing attention on the first space S1 and the first negative pressure chamber R1, but the same can be said with regard to the second space S2 and the second negative pressure chamber R2, and the excess ink Y is sucked into the suction flow path 15 via the first negative pressure chamber R1 and the second negative pressure chamber R2. In this case, similarly to the relationship between the first negative pressure chamber R1 and the second negative pressure chamber R2 illustrated in FIG. 9, the extent of the negative pressure in the second negative pressure chamber R2 is higher than that in the first negative pressure chamber R1.

### Second Embodiment

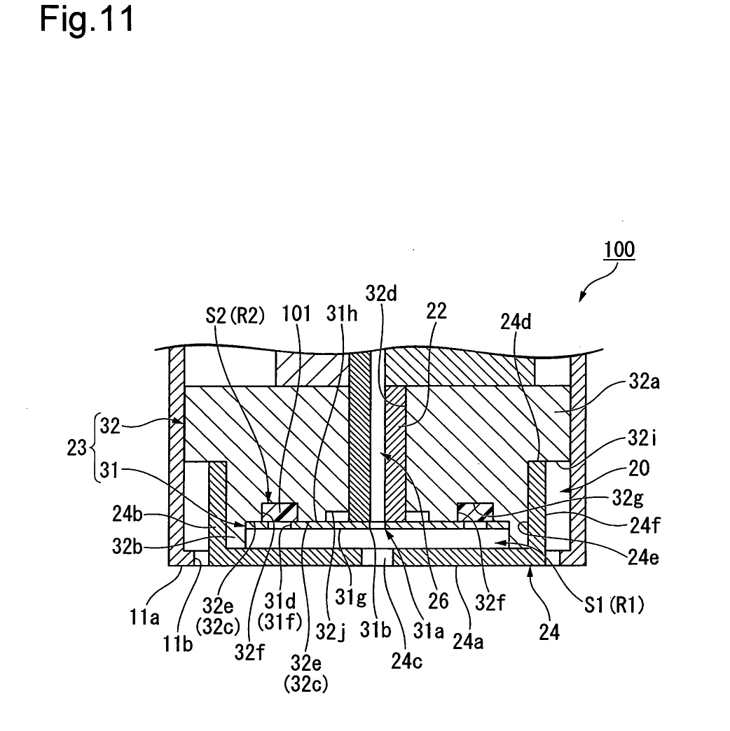

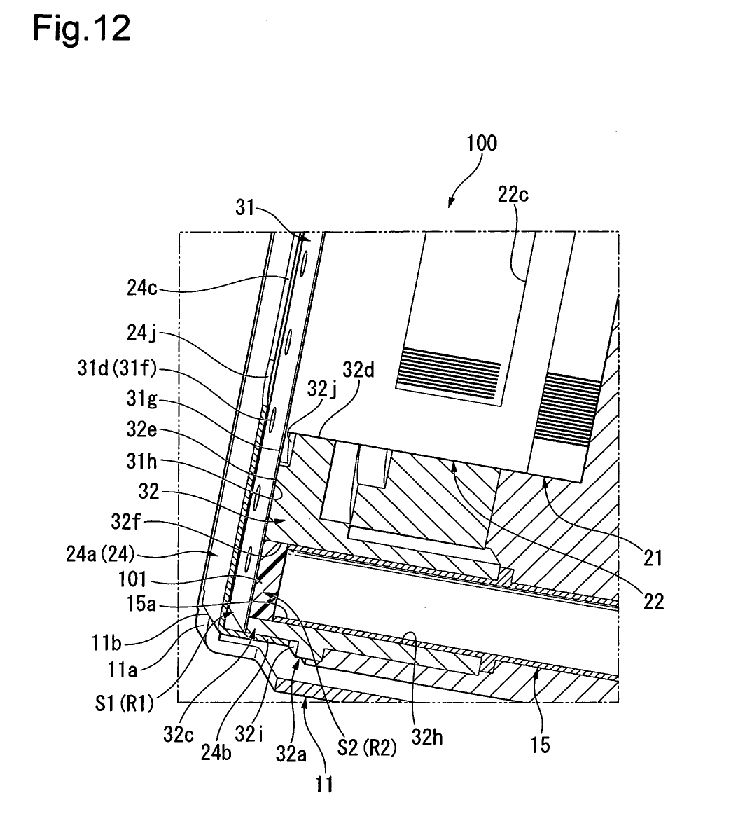

Next, a second embodiment of the present invention is described. FIG. 11 is a sectional view illustrating a principal part in the second embodiment, which is an enlarged view corresponding to FIG. 5. Further, FIG. 12 is a sectional perspective view illustrating the second embodiment, which corresponds to FIG. 8. It is to be noted that, in the following description, like numerals and symbols are used to designate like or identical members in the first embodiment described above, and description thereof is omitted.

As illustrated in FIGS. 11 and 12, an ink jet head 100 of this embodiment is different from the ink jet head according to the first embodiment described above in that an absorber 101 is disposed between a rear surface of the nozzle plate 31 and the groove portion 32f, that is, in the second space S2. More specifically, the absorber 101 is disposed so as to fill the whole region in the second space S2 and is disposed so as to surround the nozzle column 31c along the plane of the nozzle plate 31. Therefore, the communication hole group 31f in the nozzle plate 31 and the suction port 15a in the nozzle cap 32 are covered with the absorber seen in plan view.

It is to be noted that, as a material of the absorber, a porous film of such as polyvinyl alcohol (PVA) (for example, Belleater A series of Kanebo, Ltd.) or high-density polyethylene powder (for example, one manufactured by Asahi Kasei Corporation (Sunfine)) is preferably used.

In this case, the excess ink Y sucked from the communication hole group 31f into the second negative pressure chamber R2 in filling the ink I (see FIG. 10) is absorbed in the absorber 101 in the second negative pressure chamber R2. The excess ink Y absorbed in the absorber 101 is pushed out from a front surface side to a rear surface side of the absorber 101 and from above to downward by air which passes in the second negative pressure chamber R2 toward the suction port 15a, and passes through the groove portion 32f together with the air. It is to be noted that, in this embodiment, by disposing the absorber 101 in the second negative pressure chamber R2, it is difficult for air to pass through the second negative pressure chamber R2, and thus, the extent of the negative pressure in the second negative pressure chamber R2 is higher than that in the first embodiment described above. The excess ink Y which passes through the groove portion 32f flows downward in the groove portion 32f to be discharged from the suction port 15a to the waste liquid tank E.

Further, in this embodiment, as illustrated in FIG. 12, it is desirable that the suction port 15a be in contact with the absorber 101. More specifically, because, if the suction port 15a is in contact with the absorber 101, suction power is directly applied to the excess ink Y contained in the absorber 101 with no space therebetween, the excess ink Y contained in the absorber 101 can be discharged more effectively.

Therefore, according to this embodiment, not only effects similar to those of the first embodiment described above are produced, but also, because the absorber 101 is disposed in the second space S2, the excess ink Y sucked into the second negative pressure chamber R2 can be reliably absorbed and the excess ink Y can be prevented from leaking to the first negative pressure chamber R1 via the communication hole group 31f.

Further, because the absorber 101 is disposed in the second negative pressure chamber R2 so as to cover the suction port 15a, the excess ink Y absorbed in the absorber 101 can be continuously sucked, and the absorber 101 can be promptly dried and saturation of absorption by the absorber 101 can be suppressed.

### Third Embodiment

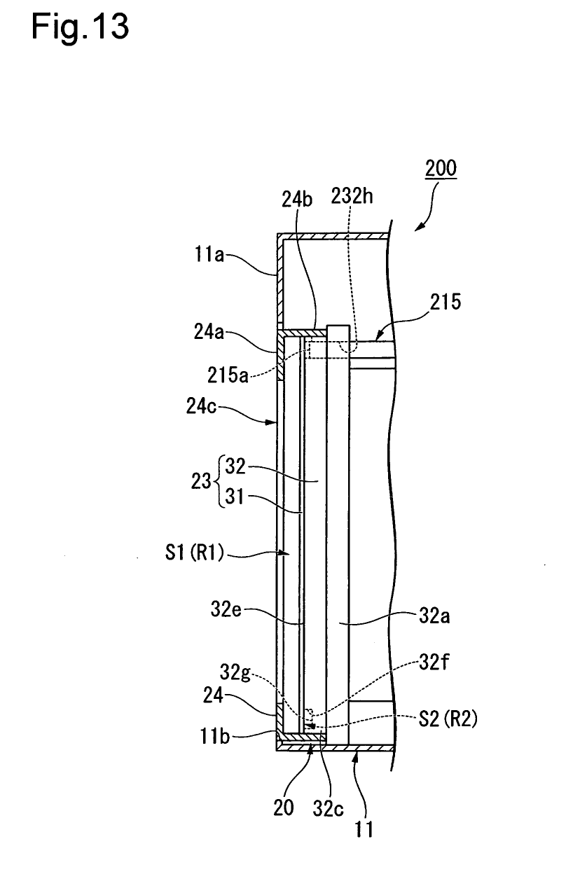

Next, a third embodiment of the present invention is described. FIG. 13 is a schematic structural view of an ink jet head seen from a right side in the third embodiment. It is to be noted that, in the following description, like numerals and symbols are used to designate like or identical members in the first and second embodiments described above, and description thereof is omitted.

As illustrated in FIG. 13, an inkjet head 200 of this embodiment is different from the ink jet heads according to the first and second embodiments described above in that a suction flow path 215 for sucking the excess ink Y is provided above the nozzle column 31c (see FIG. 6). More specifically, a discharge hole 232h which passes through the thickness of the inner frame surface 32e is formed in an upper portion of the inner frame portion 32c of the nozzle cap 32. One end of a tube to be a suction port 215a is fitted and inserted in the discharge hole 232h and is fixed while the other end is connected to an ink absorption hole (not shown). It is to be noted that, in this embodiment, also, the suction port 215a is open to a location which is not opposed to the slit 24c and the communication holes 31d in the nozzle plate 31 (see FIG. 6).

Further, the width dimension of the slit 24c is set to be about 1.5 mm while the nozzle diameter of the nozzle holes 31a is 40 μm. The width dimension of the slit 24c is desirably set so that the upper limit thereof is the largest size at which the suction pump 16 (see FIG. 4) can generate negative pressure in the space S1 and the space S2 and at which the ink I in the space S1 and the space S2 can flow upward against gravity and the lower limit thereof is the smallest size at which, in the initial filling of the ink I, the ink I does not overflow from the slit 24c to droop.

In this case, the excess ink Y sucked into the second negative pressure chamber R2 via the communication hole group 31f (see FIG. 6) in filling the ink flows upward (upward in the direction of gravity) in the groove portion 32f and is sucked from the suction port 215a provided above the nozzle column 31c into the suction flow path 215 to be discharged to the waste liquid tank E.

Therefore, according to the embodiment described above, because the suction flow path 215 is provided on the upper side, space below the inkjet head 200 can be effectively used to improve the space factor. Therefore, the nozzle holes 31a can be set in a lowest possible portion of the ink jet head 200, and printing on a lower end portion of the box D becomes possible.

### Fourth Embodiment

Next, a fourth embodiment of the present invention is described. FIG. 14 is a sectional view illustrating a principal part in the fourth embodiment, which is an enlarged view corresponding to FIG. 5. It is to be noted that, in the following description, like numerals and symbols are used to designate like or identical members in the first embodiment described above, and description thereof is omitted. This embodiment is different from the first embodiment described above in the shape of the nozzle cap.

As illustrated in FIG. 14, a nozzle cap 332 of an ink jet head 300 of this embodiment is a member in the shape of a frame-plate-like member with an outer periphery of one of frame surfaces being cut away, and includes a thin-plate-like outer frame portion 332a, a middle frame portion 332b which is thicker than the outer frame portion 332a, an inner frame portion 332c which is thicker than the middle frame portion 332b, and a long hole 332d which passes through the thickness at the middle portion in the direction of the short side of the inner frame portion 332c and which extends in the direction of the long side. In other words, the middle frame portion 332b and the inner frame portion 332c protrude in the thickness direction from the outer frame portion 332a so as to be step-like so that the contour of a section in the thickness direction is like stairs in which the heights of the outer frame portion 332a, the middle frame portion 332b, and the inner frame portion 332c become larger in this order toward the long hole 332d. It is to be noted that a discharge hole (not shown) which is the above-mentioned suction port 15a (see FIG. 4) is also formed in an end portion of the middle frame portion 332b.

The ring-shaped end portion 24d of the nozzle guard 24 is in abutting contact with an outer frame surface 332e of the outer frame portion 332a. Here, a groove 332f in the thickness direction of the nozzle cap 332 is formed between the airtight portion 24b of the nozzle guard 24 and the middle frame portion 332b and the inner frame portion 332c of the nozzle cap 332 so as to surround the whole periphery of the nozzle cap 332. The nozzle plate 31 having an outer shape which is equal to the outer shape of a middle frame surface 332h of the middle frame portion 332b is stuck onto an inner frame surface 332g of the inner frame portion 332c so as to block the long hole 332d and the groove 332f. Here, the nozzle holes 31a in the nozzle plate 31 are opposed to the long hole 332d in the nozzle cap 332 and the communication hole group 31f is opposed to the groove 332f.

Therefore, space between the nozzle guard 24 and the nozzle cap 332 is partitioned into the front surface 31g side and the rear surface 31h side with the nozzle plate 31 therebetween. The space specifically includes first space S11 formed between the nozzle plate 31 and the nozzle guard 24 on the front surface 31g side of the nozzle plate 31 and second space S12 formed between the nozzle plate 31 and the groove 332f on the rear surface 31h side of the nozzle plate 31. The first space S11 and the second space S12 communicate with each other via the communication hole group 31f in the nozzle plate 31.

In this case, by sucking air in the second space S12 from the suction port 15a via the suction flow path 15 with the suction pump 16, similarly to the case of the first embodiment described above, the second space S12 is depressurized to become a second negative pressure chamber R12 in which the pressure becomes negative enough compared with atmospheric pressure.

When the second space S12 becomes the second negative pressure chamber R12, air in the first space S11 flows in the second negative pressure chamber R12 via the communication hole group 31f in the nozzle plate 31, by which, similarly to the case of the first embodiment described above, the first space S11 is depressurized to become a first negative pressure chamber R11 in which the pressure becomes negative enough compared with atmospheric pressure. Air which flows from the first negative pressure chamber R11 via the communication hole group 31f in the second negative pressure chamber R12 is, as described above, sucked with the suction pump 16 via the suction flow path 15. Here, similarly to the case of the first embodiment described above, the second negative pressure chamber R12 is covered with the nozzle plate 31 and communicates with the first negative pressure chamber R11 only via the communication hole group 31f, and air flows in the second negative pressure chamber R12 only via the communication hole group 31f, and thus, the extent of the negative pressure in the second negative pressure chamber R12 is higher than that in the first negative pressure chamber R11.

Then, the excess ink Y sucked into the second negative pressure chamber R12 via the communication holes 31d is guided into the groove 332f in the second negative pressure chamber R12, and flows downward in the groove 323f to be discharged from the suction port 15a to the waste liquid tank E. This enables continuous suction of the excess ink Y absorbed in the second negative pressure chamber R12.

Therefore, according to this embodiment, not only effects similar to those of the first embodiment described above are produced, but also, only by cutting away the outer periphery of the nozzle cap 332 so as to be step-like, the groove 332f to be the second space S12 can be formed with the nozzle guard 24 and the nozzle cap 332. This can improve the manufacturing efficiency.

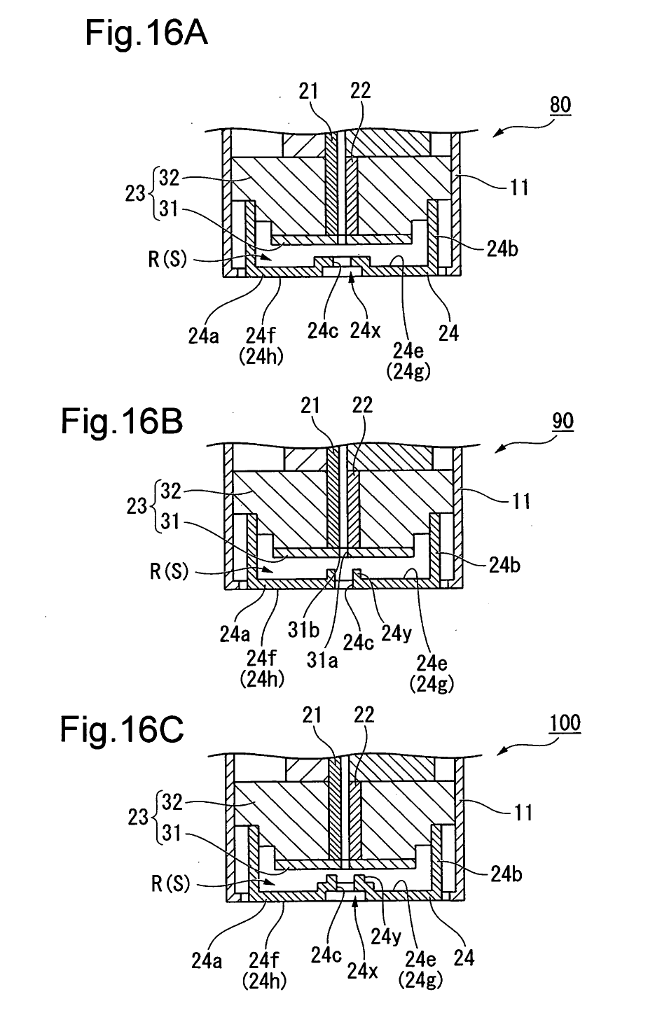

FIG. 16 illustrate modified examples of the ink jet head 10. It is to be noted that, in the respective figures, the absorber is omitted.

FIG. 16A illustrates an ink jet head 80 as a modified example of the ink jet head 10. As illustrated in FIG. 16A, a recessed portion 24x which is recessed toward the negative pressure chamber R side is formed in the top plate portion 24a of the nozzle guard 24 of the ink jet head 80. The recessed portion 24x is formed by press forming (rolling), and the slit 24c is formed in a bottom surface of the recessed portion 24x. With this, even if the box D is brought into contact with the nozzle guard 24, the probability of contact of the water-repellent film 24h in proximity to the slit 24c with the box D is reduced, and the water-repellent film 24h can be prevented from peeling off.

FIG. 16B illustrates an ink jet head 90 as a modified example of the ink jet head 10. As illustrated in FIG. 16B, a ring-shaped protruding wall 24y which protrudes to the negative pressure chamber R side and which surrounds the slit 24c in the shape of a ring is formed on the nozzle guard 24 of the ink jet head 90. With this, when the ink I is discharged toward the box D under a state in which the nozzle orifices 31b of the ink jet head 90 are oriented downward, even if the excess ink Y remains in the space S after the pressure in the negative pressure chamber R recovers, the excess ink Y can be blocked from running on the inner surface 24e to reach the slit 24c and can be prevented from leaking via the slit 24c.

FIG. 16C illustrates an ink jet head 100 as a modified example of the ink jet head 10. As illustrated in FIG. 16C, the recessed portion 24x and the ring-shaped protruding wall 24y are formed by press forming in/on the nozzle guard 24 of the ink jet head 100. With this, the water-repellent film 24h can be prevented from peeling off, and, when the ink I is discharged toward the box D under a state in which the nozzle orifices 31b of the ink jet head 100 are oriented downward, the excess ink Y can be prevented from leaking via the slit 24c.

It is to be noted that, by press forming, the recessed portion 24x and the ring-shaped protruding wall 24y can be simultaneously formed, and thus, the production efficiency becomes satisfactory.

It is to be noted that the operation procedure or the shapes and combinations of the structural members described in the above-mentioned embodiments are only exemplary, and various modifications based on design requirements and the like, which fall within the gist of the present invention, are possible.

Further, in the above-mentioned embodiments, the suction port 15a is formed to fit into the discharge hole 32h formed in the nozzle cap 32, but the discharge hole 32h may be formed in the nozzle plate 31 or in the nozzle guard 24, or, the suction flow path 15 may be connected to the discharge hole 32h and the discharge hole 32h may be the suction port 15a.

Further, in the above-mentioned embodiments, the water-repellent film 24h is formed by fluorine resin coating or Teflon (registered trademark) plating, but a water-repellent sheet may be stuck, or a water-repellent agent may be applied. Further, in the above-mentioned embodiments, the hydrophilic film 24g is formed by titanium coating, but gold plating may be given, or an alkaline agent may be applied.

Further, in the above-mentioned embodiments, the arrangement of the nozzle column 31c of the ink jet head 10 is provided in the direction of gravity and the openings of the nozzle holes 31a are provided in the horizontal direction, but the present invention is not limited to such setting directions. The openings of the nozzle holes 31a may be provided in the direction of gravity and the nozzle column 31c may be provided to extend in the horizontal direction.

Further, in the above-mentioned embodiments, the inkjet recording apparatus 1 is formed with the ink jet head 10 being fixed, but it is also possible to form the ink jet recording apparatus 1 with the ink jet head 10 being movable.

Further, there is a case in which the ink I droops from the nozzle holes 31a even when printing is carried out, and the ink I in such a case may be collected.

Further, in the above-mentioned embodiments, a case in which both the first space S1 and the second space S2 are formed in the inside space of the nozzle guard 24 is described, but the first space S1 to which the nozzle holes 31a is open may be formed in the inside space of the nozzle guard 24 and the second space S2 which communicates with the first space S1 via the communication holes may be formed outside the nozzle guard 24.

Further, in the above-mentioned second embodiment, a structure in which the absorber 101 is disposed in the second space S2 is described, but the present invention is not limited thereto, and the absorber 101 may be disposed in the first space S1. Further, the absorber 101 may be adopted in the ink jet heads 200 and 300 according to the third and fourth embodiments.

Further, in the above-mentioned embodiments, a case in which the inside space of the nozzle guard 24 is partitioned into the first space S1 and the second space S2 by the nozzle plate 31 is described, but the first space S1 and the second space S2 may be partitioned using a partitioning member which is separate from the nozzle plate 31.

Further, in the above-mentioned embodiments, a case in which the second space S2 and the communication holes 31d are formed in the shape of a ring so as to surround the nozzle column 31c is described, but design change of the range in which the second space S2 and the communication holes 31d are formed may be appropriately made. For example, the range may be only an upper semicircle or a lower semicircle around the nozzle column 31c or may be only the periphery of the suction port 15a except for a location which is opposed to the suction port 15a.

Further, in the above-mentioned embodiments, the ink I or the cleaning liquid W is filled using both the pressure pump 54 and the suction pump 16, but the present invention is not limited thereto. For example, the ink I or the cleaning liquid W may be filled into the ink jet head 10 only by operation of the suction pump 16.

Further, in the above-mentioned embodiments, as an actuator for discharging the ink I, the ceramic piezoelectric plate 21 having electrodes provided thereon is included, but the present invention is not limited thereto. For example, the mechanism in which an electrothermal conversion element is used to generate air bubbles in the chamber into which the ink I is filled and the ink I is discharged by the pressure of the air bubbles may be provided.

Further, in the above-mentioned embodiments, the open hole 22c is formed in the direction of the long grooves 26 which are provided side by side, and the ink I is filled into the long grooves 26 from the open hole 22c, but the present invention is not limited thereto. For example, it may be that the open hole 22c does not communicate with all the long grooves 26, slit-shaped grooves are provided in the ink chamber plate 22, and the pitch of providing the slits is half the pitch of providing the long grooves 26. More specifically, the slits may correspond to every other long groove 26 and the ink I may be filled into only long grooves 26 which correspond to the slits, respectively. By adopting this form, even if the used ink I is conductive, the electrodes do not establish a short circuit via the ink I, and various kinds of the ink I may be adopted to carry out printing.

Further, as illustrated in FIGS. 6 and 7, in the head chip 20 according to the embodiments described above, the open hole 22c is open to the whole long grooves 26, but the present invention is not limited thereto. For example, slits which communicate with every other long groove 26 may be formed in the ink chamber plate 22 to form the long grooves 26 into which the ink I is introduced and the long grooves 26 into which the ink I is not introduced. By adopting this form, even if the ink I is conductive, for example, the plate-like electrodes 28 on adjacent side walls 27 do not establish a short circuit and independent ink discharge may be achieved.

More specifically, the head chip described in the embodiments described above is not specifically limited, and a nonconductive oil-based ink, a conductive water-based ink, a solvent ink, a UV ink, or the like may be used. By forming the liquid jet head in this way, inks having any properties may be used. In particular, a conductive ink may be used without problems and the added value of the liquid jet recording apparatus may increase. It is to be noted that other actions and effects may be produced similarly.

Further, in the above-mentioned embodiments, as an actuator for discharging the ink I, the ceramic piezoelectric plate 21 having electrodes provided thereon is included, but the present invention is not limited thereto. For example, the mechanism may be provided, in which an electrothermal conversion element is used to generate air bubbles in the chamber into which the ink I is filled and the ink I is discharged by the pressure of the air bubbles.

Further, in the above-mentioned embodiments, as an example of the liquid jet recording apparatus, the ink jet printer 1 is described, but the present invention is not limited to a printer, and, for example, may be applied to a facsimile machine or an on-demand printer.

Further, in the above-mentioned embodiments, as illustrated in the structure of FIG. 2, the excess ink Y sucked by the suction pump 16 is discharged to the waste liquid tank E, but the present invention is not limited thereto. For example, a structure connected to the flow path on the outlet side of the suction pump 16 may be not a waste liquid tank but the ink tank 51. More specifically, the excess ink Y sucked by the suction pump 16 may be supplied to the ink tank 51 and the ink may be supplied from the ink tank 51 to the ink jet head 10 as the ink I. By adopting this form, the excess ink Y may be reused as the ink I.

In addition to this structure, in reusing the excess ink Y, a filter member may be provided in the flow path from the suction pump 16 to the ink tank 51. By adopting this structure, impurities contained in the excess ink Y may be removed and ink in an appropriate state may be supplied to the ink tank 51.

Further, in reusing the excess ink Y, a deaerator may be provided in the flow path from the suction pump 16 to the ink tank 51. By adopting this structure, air bubbles contained in the excess ink Y may be removed and ink in an appropriately deaerated state may be supplied to the ink tank 51.

However, the structures described above are not necessarily required to be used and may be appropriately used according to the specifications of a droplet jet recording apparatus.

### [Description of Symbols]

1 . . . ink jet recording apparatus (liquid jet recording apparatus)

10, 10, 200, 300 . . . ink jet head (liquid jet head)

12 . . . liquid supply system

15, 215 . . . suction flow path

15a, 215a . . . suction port

16 . . . suction pump (sucking portion)

21 . . . ceramic piezoelectric plate (actuator)

23 . . . nozzle body

24 . . . nozzle guard

24c . . . slit

31 . . . nozzle plate (partitioning portion)

31a . . . nozzle hole

31c . . . nozzle column

31d . . . communication hole

101 . . . absorber

I . . . ink (liquid)

R1, R11 . . . first negative pressure chamber

R2, R12 . . . second negative pressure chamber

S1, S11 . . . first space

S2, S12 . . . second space

1. A liquid jet head for jetting liquid from a jetting hole column, comprising:
a jetting body guard for covering a periphery of the jetting hole column, the jetting body guard having a slit formed therein which is opposed to the jetting hole column;
a suction flow path connected to a sucking portion for sucking the liquid which leaks from the jetting hole column; and
a partitioning portion for partitioning first space inside the jetting body guard and second space to which a suction port of the suction flow path is open,
wherein the partitioning portion has at least one communication hole formed therein for communication between the first space and the second space.

2. A liquid jet head according to claim 1, wherein the at least one communication hole is provided at a location which is not opposed to the suction port of the suction flow path.

3.-12. (canceled)

13. A method of filling liquid into a liquid jet head, for solving a problem in filling liquid into the liquid jet head, which includes: a jetting body guard for covering a periphery of the jetting hole column, the jetting body guard having a slit formed therein which is opposed to the jetting hole column; a suction flow path connected to a sucking portion for sucking the liquid which leaks from the jetting hole column; and a partitioning portion for partitioning first space inside the jetting body guard and second space to which a suction port of the suction flow path is open, the partitioning portion having at least one communication hole formed therein for communication between the first space and the second space, the first space and the second space being caused to be a first negative pressure chamber and a second negative pressure chamber, respectively, by the sucking portion connected to the suction flow path, the method being for sucking the liquid which overflows from the jetting holes in the first negative pressure chamber,
the method comprising, under a state in which the sucking portion causes the first negative pressure chamber and the second negative pressure chamber to be lower than atmospheric pressure, pressure-filling the liquid into pressure generating chambers which are paired with the jetting hole column and communicate with the jetting holes with a use of the liquid supply system.

14. A method of filling liquid into a liquid jet head according to claim 13, wherein the pressurized filling ends under a state in which the pressure in the first negative pressure chamber is caused to be lower than the atmospheric pressure by the sucking portion.

15. A method of filling liquid into a liquid jet head according to claim 13,
the method comprising performing a liquid filling mode in which, by operating the sucking portion by first output, the first space is caused to become a negative pressure chamber and the liquid that leaks from the jetting hole column is sucked via the suction flow path.

16. A method of filling liquid into a liquid jet head according to claim 13,
the method comprising performing switching control carried out between
a liquid filling mode in which, by operating the sucking portion by first output, the first space and the second space are caused to become the first negative pressure chamber and the second negative pressure chamber, respectively, and the liquid that leaks from the jetting hole column is sucked via the suction flow path and
a normal use mode in which the sucking portion is operated by second output which is smaller than the first output and the liquid is jetted from the jetting hole column toward a recording medium to carry out recording on the recording medium.
